(19) United States
(12) Patent Application Publication
(10) Pub. No.: US 2019/0009329 A1
(43) Pub. Date: Jan. 10, 2019

(54) PASSIVATED AND STABILIZED NANOPARTICLES AND METHODS OF PREPARING PASSIVATED NANOPARTICLES BY NANOPARTICLE CATALYZED POLYMERIZATION

(71) Applicant: Saint Louis University, St. Louis, MO (US)

(72) Inventors: Paul A. JELLISS, St. Louis, MO (US); Steven W. BUCKNER, St. Louis, MO (US); Brandon J. THOMAS, Centerville, OH (US); Evan LLOYD, Maryville, IL (US)

(73) Assignee: Saint Louis University, St. Louis, MO (US)

(21) Appl. No.: 15/752,420

(22) PCT Filed: Aug. 12, 2016
(86) PCT No.: PCT/US2016/046760

§ 371 Date: Feb. 13, 2018

Related U.S. Application Data
(60) Provisional application No. 62/205,448, filed on Aug. 14, 2015.

(51) Int. Cl. B22F 1/00; B22F 9/24; C10L 1/12

(52) U.S. Cl. CPC B22F 1/0018; B22F 1/0062; B82Y 30/00; B22F 9/24; C10L 1/1216; B22F 1/0088

(57) ABSTRACT

In some aspects, the present disclosure provides new nanomaterials which are passivized by the polymerization of an olefin catalyzed by the nanomaterial. In some embodiments, these nanomaterials exhibit increased stability in the ambient atmosphere. In other aspects, the present disclosure provides methods of preparing nanomaterials as well as use of these nanomaterials in a fuel such as a rocket fuel.

### PRIORITY CLAIM

This application claims benefit of priority to U.S. Provisional Application Ser. No. 62/205,448, filed Aug. 14, 2016, the entire contents of which are hereby incorporated by reference.

### FEDERAL GRANT SUPPORT

This invention was made with government support under Subrecipient Agreement No. RSC10011, Rev. No. 1; Prime Cooperative Agreement No. FA8650-10-2-2934 awarded by U.S. Air Force Research Lab Nanoenergetics Program and CHE-0963363 awarded by the National Science Foundation. The government has certain rights in the invention.

### BACKGROUND OF THE INVENTION

### 1. Field of the Invention

This disclosure relates to the fields of nanomaterials and energetic materials. In particular, new nanomaterials, compositions, and methods of synthesis are provided as well as methods of use thereof.

### 2. Related Art

Nanoscale aluminum is known to have one of the highest energy densities of the reactive metals and has been widely used for energetic applications. Aluminum nanoparticles have been utilized in hybrid nanoenergetic formations or as a fuel additive. Unfortunately, nanoparticles of aluminum are known to be highly reactive in ambient atmospheric conditions and in water. The reactivity of aluminum nanomaterials can be reduced by coating the surface of the nanoparticle with a polymerizable organic monomer.

The passivization of aluminum nanoparticles allows the nanoparticle to be stable in the ambient atmosphere. Polymers have been used to passivize reactive metal nanoparticle as described in U.S. Patent Publication Nos. 2012/0009424 and 2014/0034197. Of interest is the use of fluorinated organic compounds as capping agents. Fluorinated organic compounds, such as PTFE (e.g., Teflon), are considered to be good capping agents and, due to F's electronegativity, great oxidizers for Al nanoparticles (Yarrington et al., 2010; Pantoya and Dean, 2009; Watson et al., 2008). Perfluorinated organic compounds, which are good oxidizers, have been used as passivating materials for Al nanoparticles: the PVDF-coated Al nanomaterials reported by Esmaeili (Esmaeili et al., 2012), Al/fluoropolymer nanocomposites reported by Crouse et al. (2012), and the Nafion-entrapped Al nanoparticles reported by Li et al. (2009) are some examples. Jouet et al reported on the synthesis of Al nanoparticles capped with perfluoroalkyl carboxylic acids; however, the reported active Al content was 15.4%, a low value (Jouet et al., 2005). The active Al contents of the perfluorocarboxylic acid coated Al nanoparticles prepared by Kaplowitz et al. were much higher (80%); (Kaplowitz et al., 2013) however, the NPs prepared by Kaplowitz were much larger than those prepared by Jouet so the differences in active Al percentage are not completely unexpected. As such new methods of preparing reactive metal nanoparticles with passivized polymers are needed.

### SUMMARY OF THE INVENTION

In some aspects, the present disclosure provides nanoparticles which have been passivized such that the nanoparticles are less reactive in ambient conditions.

In some aspects, the present disclosure provides methods of preparing a nanoparticle comprising:
(a) adding a metal hydride with an organic solvent to form a first reaction mixture;
(b) heating the first reaction mixture to a first temperature from about 25° C. to about 200° C. and adding a titanium complex to form a reactive metal nanoparticle;
(c) adding a capping agent to the reactive metal nanoparticle to form a second reaction mixture, wherein the capping agent is a carbon-carbon double bond containing compound and a carbon-carbon triple bond containing compound; and
(d) heating the second reaction mixture to a second temperature from about 50° C. to about 200° C. for a time period from about 5 minutes to about 4 hours to produce a nanoparticle;
   wherein the nanoparticle comprises (1) a core consisting of a reactive metal nanoparticle; and (2) a coating around the core comprising a polymer consisting of the capping agent.

In some embodiments, the metal hydride is aluminum hydride. In some embodiments, the metal hydride is AlH₃. In other embodiments, the metal hydride is LiAlH₄. In other embodiments, the metal hydride is NaAlH₄. In some embodiments, the organic solvent is a hydrocarbon solvent such as an arene_{(C≤12)}. In some embodiments, the organic solvent is toluene. In some embodiments, the solvent is essentially free of water. In some embodiments, the first temperature is from about 50° C. to about 100° C. such as about 85° C.

In some embodiments, the reactive metal nanoparticle is an aluminum nanoparticle. In other embodiments, the reactive metal nanoparticle is a boron nanoparticle. In some embodiments, the titanium complex is a titanium(IV) complex such as a titanium(IV) tetraalkoxide, titanium(IV) tetrachloride, or a titanium complex with a mixture of either ligand. In some embodiments, the titanium complex is a titanium(IV) tetraalkoxide. In some embodiments, the titanium complex is Ti(OiPr)₄. In some embodiments, the titanium complex is a solution in an organic solvent such as an arene_{(C≤12)}. In some embodiments, the organic solvent is toluene.

In some embodiments, the capping agent is an alkene_{(C≤18)}. In some embodiments, the capping agent is an alkene_{(C6-18)}. In some embodiments, the capping agent is an alkene_{(C≤14)}. In some embodiments, the capping agent is 1,7-octadiene, 1,9-decadiene, 1,13-tetradecadiene, 1-octene, or 1-decene. In other embodiments, the capping agent is a substituted alkene_{(C≤18)}. In some embodiments, the capping agent is a haloalkene_{(C≤18)}. In some embodiments, the capping agent is a haloalkene_{(C6-18)}. In some embodiments, the capping agent is fluoroalkene_{(C≤18)}. In some embodiments, the capping agent is fluoroalkene_{(C6-18)}. In some embodiments, the capping agent is perfluorodecene. the capping agent is a double bond containing compound of the formula:

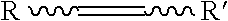

wherein: R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, nitrile or cyano, nitro, thioether (or sulfide), a second polymeric group, or a PEG group.

In other embodiments, the capping agent is an alkyne_{(C≤18)} or a substituted alkyne_{(C≤18)}. The capping agent may be an alkyne_{(C≤18)} such as 1-dodecyne or 2-heptyne. In other embodiments, the capping agent is a triple bonding containing compound of the formula:

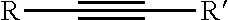

wherein: R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, nitrile or cyano, nitro, thioether (or sulfide), a second polymeric group, or a PEG group.

In some embodiments, the capping agent is added to the second reaction mixture in a ratio of the equivalents of the capping agent to the equivalents of the atoms of the reactive metal nanoparticle from about 1:1 to about 25:1. In some embodiments, the ratio of the equivalents of the capping agent to the equivalents of the atoms of the reactive metal nanoparticle is 10:1.

In some embodiments, the second temperature is from about 50° C. to about 150° C. In some embodiments, the second temperature is about 111° C. In some embodiments, the second temperature is sufficient to cause the organic solvent to reflux. In some embodiments, the time period is from 15 minutes to about 2 hours. In some embodiments, the time period is about 30 minutes.

In some embodiments, the coatings are a poly(olefin) polymer. In some embodiments, the coating is a poly(olefin) polymer prepared by the polymerization of the alkene_{(C≤18)} or substituted alkene_{(C≤18)} capping agent. In some embodiments, the coating is a poly(1,7-octadiene), poly(1,9-decadiene), poly(1,13-tetradecadiene), poly(1-octene), poly(1-decene), or poly(perfluorodecene). In other embodiments, the coating is a poly(alkyne) polymer such as a poly(alkyne) polymer prepared by the polymerization of the alkyne_{(C≤18)} or substituted alkyne_{(C≤18)} capping agent. The coating may be a poly(2-heptyne) or poly(1-dodecyne).

In some embodiments, the nanoparticles comprise a reactive metal content of greater than 50% as determined by Al speciation analysis. In some embodiments, the reactive metal content is greater than 70%. In some embodiments, the loss of reactive metal content is less than 50% of the original reactive metal content after 12 months of exposure to ambient air. In some embodiments, the loss of reactive metal content is less than 25% of the original reactive metal content. In some embodiments, the loss of reactive metal content is less than 10% of the original reactive metal content. In some embodiments, the reactive nanoparticle comprises less than 25% of metal oxide. In some embodiments, the reactive metal nanoparticle comprises less than 10% of metal oxide. In some embodiments, the reactive metal nanoparticle comprises less than 5% of the metal oxide. In some embodiments, the crystallite diameter of the nanoparticles is from about 10 nm to about 50 nm as measured by Scherrer analysis of the strong peak of the PXRD. In some embodiments, the crystallite diameter of the nanoparticle is from about 20 nm to about 40 nm.

In still yet another aspect, the present disclosure provides nanoparticles prepared by the methods described herein.

In yet another aspect, the present disclosure provides nanoparticles comprising:
(a) a core consisting of a reactive metal nanoparticle; and
(b) a self polymerized coating around the core consisting of a poly(olefin) or poly(alkyne) polymer;
   wherein the coating directly covers the core. In some embodiments, the poly(olefin) polymer is produced from an alkene_{(C≤12)} or substituted alkene_{(C≤18)}. In some embodiments, the alkene_{(C≤12)} is 1,7-octadiene, 1,9-decadiene, 1,13-tetradecadiene, 1-octene, or 1-decene. In other embodiments, the substituted alkene_{(C≤18)} is a haloalkene_{(C≤18)}. In some embodiments, the substituted alkene_{(C6-18)} is a haloalkene_{(C6-18)}. In some embodiments, the substituted alkene_{(C≤18)} is fluoroalkene_{(C≤18)}. In some embodiments, the substituted alkene_{(C6-18)} is fluoroalkene_{(C6-18)}. In some embodiments, the substituted alkene_{(C≤18)} is perfluorodecene. In some embodiments, the self polymerized coating is a poly(1,7-octadiene), poly(1,9-decadiene), poly(1,13-tetradecadiene), poly(1-octene), poly(1-decene), or poly(perfluorodecene).

In other embodiments, the poly(olefin) polymer is produced from a double bond containing compound of the formula:

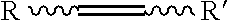

wherein: R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, cyano, nitro, thioether, a second polymeric group, or a PEG group.

In other embodiments, the poly(alkyne) polymer is a polymer produced from an alkyne_{(C≤18)} or a substituted alkyne_{(C≤18)}. The alkyne_{(C≤18)} may be 1-dodecyne or 2-heptyne and the self polymerized coating may be a poly(2-heptyne) or poly(1-dodecyne). In other embodiments, the poly(alkyne) polymer is produced from a triple bonding containing compound of the formula:

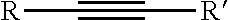

wherein: R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, cyano, nitro, thioether, a second polymeric group, or a PEG group.

In some embodiments, the nanoparticle comprises a reactive metal content of greater than 50% as determined by Al speciation analysis. In some embodiments, the reactive metal content is greater than 70%. In some embodiments, the nanoparticle has a crystallite diameter from about 10 nm to about 50 nm as measured by Scherrer analysis of the strong peak of the PXRD. In some embodiments, the crystallite diameter is from about 20 nm to about 40 nm. In some embodiments, the nanoparticle does not comprise an additional olefin polymerization catalyst.

In still yet another aspect, the present disclosure provides fuel compositions comprising a nanoparticle described herein. In some embodiments, the fuel compositions are formulated as a solid fuel. In some embodiments, the fuel compositions are useful as a propellant in a rocket.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.” The word “about” in the context of this application means within the standard error of the measurement or ±5% of the stated number. In some embodiments, the word “about” when used to describe a powder X-ray diffractions (PXRD) specta means that the value is equal to ±1° 20 or as is defined above. In some embodiments, the value is equal to about ±0.5° 20.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE FIGURES

The following drawings form part of the present specification and are included to further demonstrate certain aspects of the present disclosure. The disclosure may be better understood by reference to one or more of these drawings in combination with the detailed description.

FIG. 1 shows the TEM image of Al nanoparticles capped with poly(1,7-octadiene). TEM analysis revealed generally spheroidal single NPs.

FIG. 2 shows the DSC/TGA profiles for Al nanoparticles capped with 1-decene. Similarities amongst the thermal data sets are noted. First, the onset of nano Al oxidation was well known to occur at ˜560° C., and was noted in the DSC curves shown herein. The accompanying TGA revealed a mass increase at this point, also indicative of Al oxidation resulting from the formation of the heavier Al₂O₃. The mass loss attributed to removal of the polymer cap was quite minimal; ˜15-25% of the total sample mass prior to 400° C. The TGA for poly(epoxydodecane)-capped Al NPs showed a 50% mass loss prior to 400° C.; (Hammerstroem et al., 2011) the same trend was observed for poly(epoxydecene) and poly(epoxydecene-co-tetradecadiene)-capped Al NPs (Thomas et al., 2013).

FIG. 3 shows the DSC/TGA profiles for Al nanoparticles capped with 1,13-tetradecadiene.

FIG. 4 shows the DSC curves for Al NPs capped with various dienes.

FIG. 5 shows the effect of air exposure on active Al content of alkene-capped Al NPs over a 6 week aging period. The caps used for these aging studies were selected at random to represent the remaining simple alkenes or dienes. The decrease in active Al content appeared to follow zero order kinetics for all capping monomers tested.

FIG. 6 shows the DSC/TGA profiles of poly(tetradecadiene)-capped Al NPs after a 13 month aging period. Based on TGA data, an active Al content of 66% was calculated.

FIG. 7 shows the FTIR spectrum of Al NPs capped with poly(tetradecadiene). When analyzing the IR spectrum for Al/tetradecadiene, only one group of peaks, the triplet corresponding to sp³ C—H stretching, was observed. Several characteristic peaks of alkenes were absent from the spectrum. First, there were no peaks due to sp² C—H stretching, which are normally observed between 3095-3010 cm⁻¹. Second, the stretch of moderate intensity between 1660-1600 cm⁻¹ that is normally associated with monosubstituted alkenes was missing. Together, the presence of alkane signatures and absence of alkene signatures indicated a reduction of the diene to a saturated hydrocarbon during reaction with the nascent Al NP core.

FIG. 8 shows the FTIR spectrum of Al NPs capped with poly(decene).

FIG. 9 shows the ¹³C NMR of an extracted polydecene capping layer. The series of peaks located between 10-35 ppm (with the exception of the peak at 21.4 ppm corresponding to the methyl group carbon of toluene) were attributed to the alkyl chain of the polymer. The peaks centered at δ 30 correspond to methine carbons of the polymer. The peak at δ 22.9 was likely linked to methylene carbons, and finally, methyl carbons were likely responsible for the peak at δ 14.1. The main region of interest lies between δ 120-140, the C═C region. After subtracting the aromatic toluene peaks, no presence of a C═C bond was observed, thus indicating complete reduction of alkene to alkane.

FIG. 10 shows the ¹³C NMR of an extracted polydecadiene capping layer. The NMR for the 1,9-decadiene polymer were very similar to that of poly(decene). First, the same peaks corresponding to toluene and CDCl₃ were present. Second, aside from the toluene peaks, there were no peaks noted in the alkene region. Finally, the alkane region gave rise to methine carbon peaks near δ 30, methylene carbon peaks near δ 22, and a methyl carbon peak at 14.1 ppm. This data suggested that, as with 1-decene, the alkene functional groups are being reduced to alkanes by the Al core.

FIG. 11 shows a possible scheme for polymerization of a 1-alkene, initiated by the Al NP core itself. The radical initiator is unstable and will readily add to the C═C bond via the most electron-deficient carbon, thus reducing the alkene down to an alkane. Transfer of a π electron generates an additional radical species, thus initiating the polymerization cascade. The anionic mechanism is initiated by addition of a nucleophile to the C═C bond, leading to formation of a carbanion species. Propagation then ensues upon reaction of the carbanion with additional monomer in solution. Anionic polymerization is favored when the propagating monomer is stabilized by an electron-withdrawing substituent; otherwise, this mechanism is typically not favored.

FIG. 12 shows the TEM image of Al NPs capped with poly(perfluorodecene). The particles were spherical in nature and range from 10-30 nm in diameter. Some of the particles appeared to have core-shell morphology, indicating the presence of the perfluoro cap at the NP surface.

FIG. 13 shows the DSC/TGA for Al NPs capped with poly(perfluorodecene). Al ignition occurred at a higher temperature for the perfluorinated cap due to its heavier mass and density. The Al ignition event occurred at 610° C., a slightly higher temperature than that observed for Al NPs capped with poly(alkenes).

FIG. 14 shows the PXRD pattern of Al NPs capped with poly(perfluorodecene) after one week of water exposure. The particles were stored in a H₂O-filled vial for one week, and the PXRD of that material showed strong fcc Al peaks with no evidence of Al hydroxides.

FIGS. 15A-15E show the PXRD pattern of Al NPs capped with 1,7-octadiene (FIG. 15A), 1,9-decadiene (FIG. 15B), 1,13-tetradecadiene (FIG. 15C), 1-octene (FIG. 15D), and 1-decene (FIG. 15E).

FIGS. 16A & 16B show the PXRD patters of Al NPs capped with 2-heptyne (FIG. 16A) and 1-dodecyne (FIG. 16B).

FIG. 17 shows the effect of exposure to atmospheric conditions on the active Al contents of 2-heptyne and 1-dodecyne capped Al NPs.

FIG. 18 shows the rate of H₂ production upon exposure of Al NPs capped with alkyne monomers to concentrated NaOH.

FIGS. 19A & 19B show the TEM image of Al/2-heptyne nanomaterials (FIG. 19A) and Al/1-dodecyne nanomaterials (FIG. 19B).

FIGS. 20A & 20B show the DSC and TGA of Al/2-heptyne nanomaterials (FIG. 20A) and Al/1-dodecyne nanomaterials (FIG. 20B).

FIGS. 21A-21F show the gas chromatogram (FIGS. 21A, 21C, & 21E) and representative splitting pattern (FIGS. 21B, 21D, & 21F) of poly(2-heptyne) extracted cap, poly(1-dodecyne) extracted cap, and commercially available poly(1-decene), respectively.

FIGS. 22A & 22B show the ¹³C NMR of extracted poly(2-heptyne) capping layer (FIG. 22A) and extracted poly(1-dodecyne) capping layer (FIG. 22B).

### DESCRIPTION OF ILLUSTRATIVE EMBODIMENTS

The present disclosure provides methods of passivizing reactive metal nanoparticles comprising reacting a capping agent to form a polymeric coating around the reactive metal nanoparticle core. In some embodiments, the reactive metal nanoparticles are used to catalyze the polymerization of the capping agent. The passivized reactive metal nanoparticles may be used as additives to fuels, such as rocket fuel, to increase the energy capacity of the fuel.

### I. Reactive Metal Nanoparticles

In one aspect of the present disclosure, the present disclosure relates to the production of the reactive metal nanoparticles. Such methods of preparation are described herein and in U.S. application Ser. No. 14/259,859, U.S. Patent Application No. 2012/0009424, Tyagi, et al., 2008, and Haber and Buhro, 1998, which are incorporated herein by reference. These methods can be further optimized using techniques and methods known to a person of skill in the art without departing from the spirit and scope of the present disclosure.

It is contemplated that the nanoparticles produced may have a core diameter from about 5 nm to about 60 nm. In some embodiments, the core diameter of the nanoparticles is from 10 nm to about 50, from about 20 nm to about 40 nm, or from about 25 nm to about 35 nm. The core diameter of the reactive metal nanoparticle is from 5, 10, 15, 20, 21, 22, 23, 24, 25, 26, 27, 28, 29, 30, 31, 32, 33, 34, 35, 36, 37, 38, 39, 40, 45, 50, 55, to 60 nm, or any range derivable therein.

Additionally, the reactive metal nanoparticles may comprise greater than 50% of the reactive metal nanoparticle in the reduced (or metallic) form. In some embodiments, the amount of metal in the reduced form is greater than 70%, greater than 80%, or greater than 90%. The reactive metal nanoparticles may comprises greater than 50%, 55%, 60%, 65%, 70%, 75%, 80%, 85%, 90%, or 95%, or any range derivable therein. In some non-limiting examples, the amount of the reduced metal is measured by Al speciation analysis as described in Hammerstroem et al. (2011) or in the examples section below. Similarly, controlling the amount of metal oxide in the reactive metal nanoparticle may be used to optimize the energy density of the reaction metal nanoparticle. The amount of metal oxide in the reactive nanoparticle, in some embodiments, is less than 25%, less than 10%, or less than 5%. The amount of metal oxide in the reactive metal nanoparticle may be less than 25%, 20%, 15%, 14%, 13%, 12%, 11%, 10%, 9%, 8%, 7%, 6%, 5%, 4%, 3%, 2%, or 1%, or any range derivable therein. Methods of determining the amount of reactive metal and metal oxide can be found in Hammerstroem, et al., 2011, which is incorporated herein by reference.

The nanoparticles of the disclosure may also have the advantage that they may be more efficacious than, cheaper to produce than, and/or have other useful physical or chemical properties over, other nanoparticles known in the prior art, whether for use in the manners stated herein or otherwise.

In addition, atoms making up aluminum nanoparticles are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C. Isotopes of lithium, sodium, and aluminum are also contemplated in the compounds so long as the isotopes are stable.

### II. Capping of Reactive Metal Nanoparticles to Modulate Reactivity

In some aspects, the reactive metal nanoparticles are passivized by the polymerization of an epoxide or an alkene around the reactive metal nanoparticle. The polymers as passivization may be used to decrease the reactivity to the ambient atmosphere such as ambient water or ambient oxygen. In some embodiments, the reactive metal nanoparticles are capped by the polymerization of an alkene or substituted alkene. These alkenes that may be used include alkenes_{(C≤30)} or substituted alkenes_{(C≤30)}. In some embodiments, the substituted alkenes include haloalkenes, such as fluoroalkenes. The alkenes or substituted alkenes that maybe used include alkenes with alkyl links from 2 carbons to 30 carbons, from 2 carbons to 18 carbons, or from about 6 carbons to 18 carbons. In some embodiments, the capping materials used include one or more fluoride atoms.

In other embodiments, the nanoparticle may be capped using capping agent which is a carbon-carbon double bond containing compound of the formula:

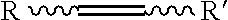

wherein R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, nitrile or cyano, nitro, thioether (or sulfide), a second polymeric group, or a PEG group. In some embodiments, the carbon-carbon double bond containing compound group comprises one or more fluorine atoms.

The PEG group which is joined to these groups include a polyethylene group with from 1 to 250 ethylene repeating units. In some embodiments, the PEG group has an average molecular weight from about 100 g/mol to about 50,000 g/mol. The PEG group may have an average molecular weight from about 100, 200, 300, 400, 500, 750, 1,000, 2,000, 3,000, 4,000, 5,000, 10,000, 12,500, 15,000, 17,500, 20,000, 25,000, 30,000 to about 40,000 g/mol.

In other embodiments, the group is attached to a single polymeric group such as a polyether such as a polyethylene glycol or polypropylene glycol; a polyacrylate such as polyacrylate, polymethacyrlate, or polymethylmethacyrlate; or a polyolefin such as polyethylene, polypropylene, polystyrene, or polyethyleneterephthalate. These polymers may have an average molecular weight from about 100 g/mol to about 50,000 g/mol. The polymer may have an average molecular weight from about 100, 200, 300, 400, 500, 750, 1,000, 2,000, 3,000, 4,000, 5,000, 10,000, 12,500, 15,000, 17,500, 20,000, 25,000, 30,000 to about 40,000 g/mol.

When the reactive metal nanoparticle is an aluminum nanoparticle, the use of fluoro capping material is contemplated due to the synergistic activity of the aluminum nanoparticle with fluoride for energetic purposes. The formation of aluminium fluoride (AlF₃, Reaction 1) from metallic Al yields 56.10 kJ/g of energy, nearly twice the amount of energy released upon the formation of Al₂O₃ from Al.

4nAl+3(C₂F₄)ₙ→4nAlF₃+6nC (1)

In another embodiment, the present disclosure contemplates that the nanoparticles may be capped with a capping agent which forms a poly(alkyne) cap. The poly(alkyne) may be formed from an alkyne_{(C≤30)} or a substituted alkyne_{(C≤30)} as a capping agent. The alkyne may be an internal alkyne (e.g. an alkyne in which both of the bonds on either side of the carbon-carbon triple bond are non-hydrogen groups). Without wishing to be bound by any theory, it is believed that terminal hydrogen atoms may reduce the polymerization efficiency of the reaction. In other embodiments, the carbon-carbon triple bond is a terminal alkyne. A terminal alkyne is an alkyne in which one of the bonds to the carbon-carbon triple bond is to a hydrogen atom. While, in some embodiments, the terminal hydrogen atom may reduce the amount of polymerization, these alkynes can result in sufficient polymerization to reduce the reactivity of the nanoparticle. In other embodiments, the nanoparticle may be capped using capping agent which is a carbon-carbon triple bond containing compound of the formula:

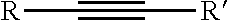

wherein R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, nitrile or cyano, nitro, thioether (or sulfide), a second polymeric group, or a PEG group. In some embodiments, the carbon-carbon triple bond containing compound group comprises one or more fluorine atoms.

The PEG group which is joined to these groups include a polyethylene group with from 1 to 250 ethylene repeating units. In some embodiments, the PEG group has an average molecular weight from about 100 g/mol to about 50,000 g/mol. The PEG group may have an average molecular weight from about 100, 200, 300, 400, 500, 750, 1,000, 2,000, 3,000, 4,000, 5,000, 10,000, 12,500, 15,000, 17,500, 20,000, 25,000, 30,000 to about 40,000 g/mol.

In other embodiments, the group is attached to a single polymeric group such as a polyether such as a polyethylene glycol or polypropylene glycol; a polyacrylate such as polyacrylate, polymethacyrlate, or polymethylmethacyrlate; or a polyolefin such as polyethylene, polypropylene, polystyrene, or polyethyleneterephthalate. These polymers may have an average molecular weight from about 100 g/mol to about 50,000 g/mol. The polymer may have an average molecular weight from about 100, 200, 300, 400, 500, 750, 1,000, 2,000, 3,000, 4,000, 5,000, 10,000, 12,500, 15,000, 17,500, 20,000, 25,000, 30,000 to about 40,000 g/mol.

An Al nanoparticle passivated with an oxidizing material is favorable; the diffusional kinetics between reactive metals and the oxidizer can hinder the energetic release (Kappagantula et al., 2012); diffusion is improved by directly binding the oxidizer to the Al nanoparticle surface (Kaplowitz et al., 2014 and Slocik et al., 2013).

In some aspects, the reactive metal nanoparticles may be passivized such that the reduction in the amount of the reduced (or metallic) form of the metal is less than 50% over a 12 month period. In some embodiments, the reduction in the amount of the reduced form of the metal is less than 25%, less than 10%, or less than 5%. The reduction in the amount of the reduced form of the metal is less than 50%, 40%, 30%, 25%, 20%, 15%, 10%, 9%, 8%, 7%, 6%, or 5%, or any range derivable therein. Similarly, the reduction in the amount of the reduced (or metallic) form of the metal is less when the passivized reactive metal nanoparticle is exposed to the ambient atmosphere for a shorter period of time.

### III. High Energy Applications of Reactive Metal Nanoparticles

Metallic aluminum has one of the highest combustion enthalpies (Dreizin, 2009). In some aspects of the present disclosure, the use of aluminum complexes and nanomaterials has been widely sought after to produce fuels or fuel additives containing higher energy content but the ease in which an aluminum oxide layer can form posses a major hurdle for their use. In particular embodiments of the present disclosure, nanoparticles are especially effective when added to fuel systems because the nanoparticles contain a significantly higher surface area leading to such favorable properties as shorter ignition delays, decreased burn times, and an increased and more complete combustion. Furthermore, in some embodiments, the addition of the nanoparticles enhances the physical properties of the material which result in more desirable properties for the fluids use as a fuel. In some embodiments, these compounds and compositions may be added to liquid and other solid fuels to increase the energy content of the fuel. The addition of aluminum materials into fuels to increase the energy content is taught by Gan and Qiao (2010) and by Tyagi et al. (2008), both of which are incorporated herein by references. In some embodiments, the aluminum compounds and compositions may be added to jet or rocket fuel to increase its energy content.

### IV. Synthetic Methods

In some aspects, the compounds of this disclosure can be synthesized using the methods of organic and organometallic chemistry as described in this application. These polymerization methods used to cap the nanoparticles can be further modified and optimized using the principles and techniques of organic chemistry as applied by a person skilled in the art. Such principles and techniques are taught, for example, in March's Advanced Organic Chemistry: Reactions, Mechanisms, and Structure (2007), which is incorporated by reference herein. The methods recited in this disclosure may be further modified and optimized using the principles and techniques of nanoparticle production as applied by a person of skill in the art which are taught, for example, in Nanostructures and Nanomaterials: Synthesis, Properties, and Applications by Cao and Wang, 2011, which is incorporated by reference herein.

### V. Definitions

When used in the context of a chemical group: “hydrogen” means —H; “hydroxy” means —OH; “oxo” means ═O; “carbonyl” means —C(═O)—; “carboxy” means —C(═O)OH (also written as —COOH or —CO₂H); “halo” means independently —F, —Cl, —Br or —I; “amino” means —NH₂; “hydroxyamino” means —NHOH; “nitro” means NO₂; imino means ═NH; “cyano” or “nitrile” means —CN; “isocyanate” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; and “thio” means=S; “sulfonyl” means —S(O)₂—; “hydroxysulfonyl” means —S(O)₂OH; “aminosulfonyl” means —S(O)₂NH₂; and “sulfinyl” means —S(O)—.

In the context of chemical formulas, the symbol “—” means a single bond, “═” means a double bond, and “≡” means triple bond. The symbol “ [symbol] ” represents an optional bond, which if present is either single or double. The symbol “ [symbol] ” represents a single bond or a double bond. Thus, for example, the formula

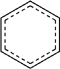

includes

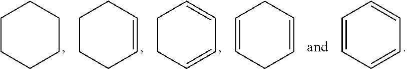

And it is understood that no one such ring atom forms part of more than one double bond. Furthermore, it is noted that the covalent bond symbol “—”, when connecting one or two stereogenic atoms, does not indicate any preferred stereochemistry. Instead, it cover all stereoisomers as well as mixtures thereof. The symbol “ [symbol] ”, when drawn perpendicularly across a bond (e.g.,

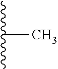

for methyl) indicates a point of attachment of the group. It is noted that the point of attachment is typically only identified in this manner for larger groups in order to assist the reader in unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means a single bond where the geometry around a double bond (e.g., either E or Z) is undefined. Both options, as well as combinations thereof are therefore intended. The bond orders described above are not limiting when one of the atoms connected by the bond is a metal atom (M). In such cases, it is understood that the actual bonding may comprise significant multiple bonding and/or ionic character. Therefore, unless indicated otherwise, the formulas M-C, M=C M [symbol] C, and M [symbol] C, each refers to a bond of any and type and order between a metal atom and a carbon atom. Any undefined valency on an atom of a structure shown in this application implicitly represents a hydrogen atom bonded to that atom. A bold dot on a carbon atom indicates that the hydrogen attached to that carbon is oriented out of the plane of the paper.

When a group “R” is depicted as a “floating group” on a ring system, for example, in the formula:

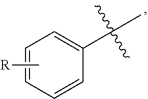

then R may replace any hydrogen atom attached to any of the ring atoms, including a depicted, implied, or expressly defined hydrogen, so long as a stable structure is formed. When a group “R” is depicted as a “floating group” on a fused ring system, as for example in the formula:

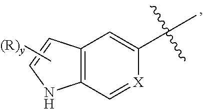

then R may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the group “R” enclosed in parentheses, represents a numeric variable. Unless specified otherwise, this variable can be 0, 1, 2, or any integer greater than 2, only limited by the maximum number of replaceable hydrogen atoms of the ring or ring system.

For the groups and classes below, the following parenthetical subscripts further define the group/class as follows: “(Cn)” defines the exact number (n) of carbon atoms in the group/class. “(C≤n)” defines the maximum number (n) of carbon atoms that can be in the group/class, with the minimum number as small as possible for the group in question, e.g., it is understood that the minimum number of carbon atoms in the group “alkenyl_{(C≤8)}” or the class “alkene_{(C≤8)}” is two. (Cn-n′) defines both the minimum (n) and maximum number (n′) of carbon atoms in the group. Similarly, “alkyl_{(C2-10)}” designates those alkyl groups having from 2 to 10 carbon atoms.

The term “saturated” as used herein means the compound or group so modified has no carbon-carbon double and no carbon-carbon triple bonds, except as noted below. In the case of substituted versions of saturated groups, one or more carbon oxygen double bond or a carbon nitrogen double bond may be present. And when such a bond is present, then carbon-carbon double bonds that may occur as part of keto-enol tautomerism or imine/enamine tautomerism are not precluded.

The term “aliphatic” when used without the “substituted” modifier signifies that the compound/group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single bonds (alkanes/alkyl), or unsaturated, with one or more double bonds (alkenes/alkenyl) or with one or more triple bonds (alkynes/alkynyl).

The term “aromatic” when used to modify a compound or a chemical group refers to a planar unsaturated ring of atoms with 4n+2 electrons in a fully conjugated cyclic π system.

The term “alkyl” when used without the “substituted” modifier refers to a monovalent saturated aliphatic group with a carbon atom as the point of attachment, a linear or branched, cyclo, cyclic or acyclic structure, and no atoms other than carbon and hydrogen. Thus, as used herein cycloalkyl is a subset of alkyl, with the carbon atom that forms the point of attachment also being a member of one or more non-aromatic ring structures wherein the cycloalkyl group consists of no atoms other than carbon and hydrogen. As used herein, the term does not preclude the presence of one or more alkyl groups (carbon number limitation permitting) attached to the ring or ring system. The groups —CH₃ (Me), —CH₂CH₃ (Et), —CH₂CH₂CH₃ (n-Pr or propyl), —CH(CH₃)₂ (i-Pr, ⁱPr or isopropyl), —CH(CH₂)₂ (cyclopropyl), —CH₂CH₂CH₂CH₃ (n-Bu), —CH(CH₃)CH₂CH₃ (sec-butyl), —CH₂CH(CH₃)₂ (isobutyl), —C(CH₃)₃ (tert-butyl, t-butyl, t-Bu or ^{t}Bu), —CH₂C(CH₃)₃ (neo-pentyl), cyclobutyl, cyclopentyl, cyclohexyl, and cyclohexylmethyl are non-limiting examples of alkyl groups. The term “alkanediyl” when used without the “substituted” modifier refers to a divalent saturated aliphatic group, with one or two saturated carbon atom(s) as the point(s) of attachment, a linear or branched, cyclo, cyclic or acyclic structure, no carbon-carbon double or triple bonds, and no atoms other than carbon and hydrogen. The groups, —CH₂— (methylene), —CH₂CH₂—, —CH₂C(CH₃)₂CH₂—, —CH₂CH₂CH₂—, and

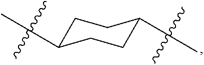 [SMILES: *C1CCC(*)CC1]

are non-limiting examples of alkanediyl groups. The term “alkylidene” when used without the “substituted” modifier refers to the divalent group ═CRR′ in which R and R′ are independently hydrogen, alkyl, or R and R′ are taken together to represent an alkanediyl having at least two carbon atoms. Non-limiting examples of alkylidene groups include: ═CH₂, ═CH(CH₂CH₃), and ═C(CH₃)₂. An “alkane” refers to the compound H—R, wherein R is alkyl as this term is defined above. An “epoxide” is an alkane as that term is defined above wherein a hydrogen atom on two adjacent carbons has been removed and replaced with a divalent oxygen such that the oxygen forms a three membered ring with the carbon chain. When any of these terms is used with the “substituted” modifier one or more hydrogen atom has been independently replaced by —OH, —F, —Cl, —Br, —I, —NH₂, —NO₂, —N₃, —CO₂H, —CO₂CH₃, —CN, —SH, —OCH₃, —SCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂. The following groups are non-limiting examples of substituted alkyl groups: —CH₂OH, —CH₂C1, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂Cl. The term “haloalkyl” is a subset of substituted alkyl, in which one or more hydrogen atoms has been substituted with a halo group and no other atoms aside from carbon, hydrogen and halogen are present. The group, —CH₂Cl is a non-limiting example of a haloalkyl. The term “fluoroalkyl” is a subset of substituted alkyl, in which one or more hydrogen has been substituted with a fluoro group and no other atoms aside from carbon, hydrogen and fluorine are present. The groups, —CH₂F, —CF₃, and —CH₂CF₃ are non-limiting examples of fluoroalkyl groups.

The term “alkenyl” when used without the “substituted” modifier refers to an monovalent unsaturated aliphatic group with a carbon atom as the point of attachment, a linear or branched, cyclo, cyclic or acyclic structure, at least one nonaromatic carbon-carbon double bond, no carbon-carbon triple bonds, and no atoms other than carbon and hydrogen. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, and —CH═CHCH═CH₂. The term “alkenediyl” when used without the “substituted” modifier refers to a divalent unsaturated aliphatic group, with two carbon atoms as points of attachment, a linear or branched, cyclo, cyclic or acyclic structure, at least one nonaromatic carbon-carbon double bond, no carbon-carbon triple bonds, and no atoms other than carbon and hydrogen. The groups, —CH═CH—, —CH═C(CH₃)CH₂—, —CH═CHCH₂—, and

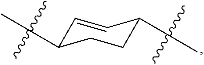 [SMILES: *C1C=CC(*)CC1]

are non-limiting examples of alkenediyl groups. It is noted that while the alkenediyl group is aliphatic, once connected at both ends, this group is not precluded from forming part of an aromatic structure. The terms “alkene” or “olefin” are synonymous and refer to a compound having the formula H—R, wherein R is alkenyl as this term is defined above. A “terminal alkene” refers to an alkene having a carbon-carbon double bond, wherein that bond forms a vinyl group at one end of the molecule. When any of these terms are used with the “substituted” modifier one or more hydrogen atom has been independently replaced by —OH, —F, —Cl, —Br, —I, —NH₂, —NO₂, —N₃, —CO₂H, —CO₂CH₃, —CN, —SH, —OCH₃, —SCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂. The groups, —CH═CHF, —CH═CHCl and —CH═CHBr, are non-limiting examples of substituted alkenyl groups. The term “haloalkenyl” is a subset of substituted alkenyl, in which one or more hydrogen atoms has been substituted with a halo group and no other atoms aside from carbon, hydrogen and halogen are present. The group, —CH═CHCH₂C1 is a non-limiting example of a haloalkenyl. The term “fluoroalkenyl” is a subset of substituted alkenyl and haloalkenyl, in which one or more hydrogen has been substituted with a fluoro group and no other atoms aside from carbon, hydrogen and fluorine are present. The groups, —CH═CHF, —CF═CF₂, and —CH═CHCF₃ are non-limiting examples of fluoroalkenyl groups.

The term “alkynyl” when used without the “substituted” modifier refers to a monovalent unsaturated aliphatic group with a carbon atom as the point of attachment, a linear or branched acyclic structure, at least one carbon-carbon triple bond, and no atoms other than carbon and hydrogen. As used herein, the term alkynyl does not preclude the presence of one or more non-aromatic carbon-carbon double bonds. The groups —C≡CH, —C≡CCH₃, and —CH₂C≡CCH₃ are non-limiting examples of alkynyl groups. An “alkyne” refers to the class of compounds having the formula H—R, wherein R is alkynyl. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “aryl” when used without the “substituted” modifier refers to a monovalent unsaturated aromatic group with an aromatic carbon atom as the point of attachment, said carbon atom forming part of a one or more six-membered aromatic ring structure, wherein the ring atoms are all carbon, and wherein the group consists of no atoms other than carbon and hydrogen. If more than one ring is present, the rings may be fused or unfused. As used herein, the term does not preclude the presence of one or more alkyl or aralkyl groups (carbon number limitation permitting) attached to the first aromatic ring or any additional aromatic ring present.

Non-limiting examples of aryl groups include phenyl (Ph), methylphenyl, (dimethyl)phenyl, —C₆H₄CH₂CH₃ (ethylphenyl), naphthyl, and a monovalent group derived from biphenyl. The term “arenediyl” when used without the “substituted” modifier refers to a divalent aromatic group with two aromatic carbon atoms as points of attachment, said carbon atoms forming part of one or more six-membered aromatic ring structure(s) wherein the ring atoms are all carbon, and wherein the monovalent group consists of no atoms other than carbon and hydrogen. As used herein, the term does not preclude the presence of one or more alkyl, aryl or aralkyl groups (carbon number limitation permitting) attached to the first aromatic ring or any additional aromatic ring present. If more than one ring is present, the rings may be fused or unfused. Unfused rings may be connected via one or more of the following: a covalent bond, alkanediyl, or alkenediyl groups (carbon number limitation permitting). Non-limiting examples of arenediyl groups include:

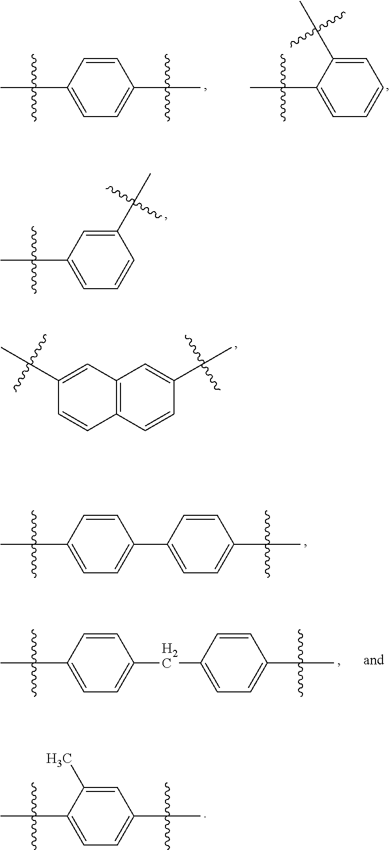

An “arene” refers to the class of compounds having the formula H—R, wherein R is aryl as that term is defined above. Benzene and toluene are non-limiting examples of arenes. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “aralkyl” when used without the “substituted” modifier refers to the monovalent group -alkanediyl-aryl, in which the terms alkanediyl and aryl are each used in a manner consistent with the definitions provided above. Non-limiting examples are: phenylmethyl (benzyl, Bn) and 2-phenyl-ethyl. When the term aralkyl is used with the “substituted” modifier one or more hydrogen atom from the alkanediyl and/or the aryl group has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. Non-limiting examples of substituted aralkyls are: (3-chlorophenyl)-methyl, and 2-chloro-2-phenyl-eth-1-yl.

The term “heteroaryl” when used without the “substituted” modifier refers to a monovalent aromatic group with an aromatic carbon atom or nitrogen atom as the point of attachment, said carbon atom or nitrogen atom forming part of one or more aromatic ring structures wherein at least one of the ring atoms is nitrogen, oxygen or sulfur, and wherein the heteroaryl group consists of no atoms other than carbon, hydrogen, aromatic nitrogen, aromatic oxygen and aromatic sulfur. If more than one ring is present, the rings may be fused or unfused. As used herein, the term does not preclude the presence of one or more alkyl, aryl, and/or aralkyl groups (carbon number limitation permitting) attached to the aromatic ring or aromatic ring system. Non-limiting examples of heteroaryl groups include furanyl, imidazolyl, indolyl, indazolyl (Im), isoxazolyl, methylpyridinyl, oxazolyl, phenylpyridinyl, pyridinyl (pyridyl), pyrrolyl, pyrimidinyl, pyrazinyl, quinolyl, quinazolyl, quinoxalinyl, triazinyl, tetrazolyl, thiazolyl, thienyl, and triazolyl. The term “N-heteroaryl” refers to a heteroaryl group with a nitrogen atom as the point of attachment. A “heteroarene” refers to the class of compounds having the formula H—R, wherein R is heteroaryl. Pyridine and quinoline are non-limiting examples of heteroarenes. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “heterocycloalkyl” when used without the “substituted” modifier refers to a monovalent non-aromatic group with a carbon atom or nitrogen atom as the point of attachment, said carbon atom or nitrogen atom forming part of one or more non-aromatic ring structures wherein at least one of the ring atoms is nitrogen, oxygen or sulfur, and wherein the heterocycloalkyl group consists of no atoms other than carbon, hydrogen, nitrogen, oxygen and sulfur. If more than one ring is present, the rings may be fused or unfused. As used herein, the term does not preclude the presence of one or more alkyl groups (carbon number limitation permitting) attached to the ring or ring system. Also, the term does not preclude the presence of one or more double bonds in the ring or ring system, provided that the resulting group remains non-aromatic. Non-limiting examples of heterocycloalkyl groups include aziridinyl, azetidinyl, pyrrolidinyl, piperidinyl, piperazinyl, morpholinyl, thiomorpholinyl, tetrahydrofuranyl, tetrahydrothiofuranyl, tetrahydropyranyl, pyranyl, oxiranyl, and oxetanyl. The term “N-heterocycloalkyl” refers to a heterocycloalkyl group with a nitrogen atom as the point of attachment. N-pyrrolidinyl is an example of such a group. An “epoxide” is a group with a saturated three membered ring containing two carbon atoms and an oxygen atom. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂₀H, or —S(O)₂NH₂.

The term “acyl” when used without the “substituted” modifier refers to the group —C(O)R, in which R is a hydrogen, alkyl, cycloalkyl, or aryl as those terms are defined above. The groups, —CHO, —C(O)CH₃ (acetyl, Ac), —C(O)CH₂CH₃, —C(O)CH(CH₃)₂, —C(O)CH(CH₂)₂, —C(O)C₆H₅, and —C(O)C₆H₄CH₃ are non-limiting examples of acyl groups. A “thioacyl” is defined in an analogous manner, except that the oxygen atom of the group —C(O)R has been replaced with a sulfur atom, —C(S)R. The term “aldehyde” corresponds to an alkyl group, as defined above, attached to a —CHO group. Similarly, the term “ketone” corresponds to a —C(O)— group wherein the both sides of the carbonyl group is attached to an aliphatic or aromatic group. Additionally, the term “ester” describes the group —C(O)OR, wherein R is an aliphatic or aromatic group. When any of these terms are used with the “substituted” modifier one or more hydrogen atom (including a hydrogen atom directly attached to the carbon atom of the carbonyl or thiocarbonyl group, if any) has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂₀H, or —S(O)₂NH₂. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

The term “alkoxy” when used without the “substituted” modifier refers to the group —OR, in which R is an alkyl, as that term is defined above. Non-limiting examples include: —OCH₃ (methoxy), —OCH₂CH₃ (ethoxy), —OCH₂CH₂CH₃, —OCH(CH₃)₂ (isopropoxy), —OC(CH₃)₃ (tert-butoxy), —OCH(CH₂)₂, —O-cyclopentyl, and —O-cyclohexyl. The terms “cycloalkoxy”, “alkenyloxy”, “alkynyloxy”, “aryloxy”, “aralkoxy”, “heteroaryloxy”, “heterocycloalkoxy”, and “acyloxy”, when used without the “substituted” modifier, refers to groups, defined as —OR, in which R is cycloalkyl, alkenyl, alkynyl, aryl, aralkyl, heteroaryl, heterocycloalkyl, and acyl, respectively. The term “alkylthio” and “acylthio” when used without the “substituted” modifier refers to the group —SR, in which R is an alkyl and acyl, respectively. The term “alcohol” corresponds to an alkane, as defined above, wherein at least one of the hydrogen atoms has been replaced with a hydroxy group. The term “ether” corresponds to an alkane, as defined above, wherein at least one of the hydrogen atoms has been replaced with an alkoxy group. The term “thioether” or “sulfide” corresponds to an alkane, as defined above, wherein at least one of the hydrogen atoms has been replaced with an alkylthio group. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂₀H, or —S(O)₂NH₂.

The term “alkylamino” when used without the “substituted” modifier refers to the group —NHR, in which R is an alkyl, as that term is defined above. Non-limiting examples include: —NHCH₃ and —NHCH₂CH₃. The term “dialkylamino” when used without the “substituted” modifier refers to the group —NRR′, in which R and R′ can be the same or different alkyl groups, or R and R′ can be taken together to represent an alkanediyl. Non-limiting examples of dialkylamino groups include: —N(CH₃)₂ and —N(CH₃)(CH₂CH₃). The terms “cycloalkylamino”, “alkenylamino”, “alkynylamino”, “arylamino”, “aralkylamino”, “heteroarylamino”, “heterocycloalkylamino”, “alkoxyamino”, and “alkylsulfonylamino” when used without the “substituted” modifier, refers to groups, defined as —NHR, in which R is cycloalkyl, alkenyl, alkynyl, aryl, aralkyl, heteroaryl, heterocycloalkyl, alkoxy, and alkylsulfonyl, respectively. A non-limiting example of an arylamino group is —NHC₆H₅. The term “amido” (acylamino), when used without the “substituted” modifier, refers to the group —NHR, in which R is acyl, as that term is defined above. A non-limiting example of an amido group is —NHC(O)CH₃. The term “alkylimino” when used without the “substituted” modifier refers to the divalent group ═NR, in which R is an alkyl, as that term is defined above. When any of these terms is used with the “substituted” modifier one or more hydrogen atom attached to a carbon atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂₀H, or —S(O)₂NH₂. The groups —NHC(O)OCH₃ and —NHC(O)NHCH₃ are non-limiting examples of substituted amido groups.

The terms “alkylsulfonyl” and “alkylsulfinyl” when used without the “substituted” modifier refers to the groups —S(O)₂R and —S(O)R, respectively, in which R is an alkyl, as that term is defined above. The terms “cycloalkylsulfonyl”, “alkenylsulfonyl”, “alkynylsulfonyl”, “arylsulfonyl”, “aralkylsulfonyl”, “heteroarylsulfonyl”, and “heterocycloalkylsulfonyl” are defined in an analogous manner. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂₀H, or —S(O)₂NH₂.

In the context of this application, “organic solvent” refers to a solvent which comprises at least one carbon atom. A “polar organic solvent” refers to a solvent which comprises a net dipole moment on at least one portion of the molecule or within one functional group attached to the molecule. In some embodiments, the organic solvent is selected from pentane, hexane, cyclohexane, acetonitrile, dichloromethane, chloroform, nitromethane, benzene, toluene, xylene, methanol, ethanol, isopropanol, tert-butanol, diethyl ether, tetrahydrofuran, ethyl acetate, dimethylformamide, or dimethylacetamide. In some non-limiting examples, acetonitrile, dichloromethane, chloroform, nitromethane, methanol, ethanol, isopropanol, tert-butanol, diethyl ether, tetrahydrofuran, dimethylformamide, ethyl acetate, or dimethylacetamide are polar organic solvents. In some embodiments, an aprotic polar organic solvent comprises acetonitrile, dichloromethane, chloroform, nitromethane, diethyl ether, tetrahydrofuran, ethyl acetate, dimethylformamide, or dimethylacetamide. In some embodiments, the organic solvent is a hydrocarbon solvent. Some non-limiting examples of hydrocarbon solvents include butane, pentane, hexane, cyclohexane, butene, cyclohexene, benzene, toluene, or xylene.

The other abbreviations used throughout this application include Al NP, aluminum nanoparticles; NP(s), nanoparticle(s); iPr, isopropyl, M, molar; nm, nanometer; mL or ml, milliliter; μL, microliter; kV, kilovolt; and IR or FTIR, Fourier-transform infrared spectroscopy.

### VI. Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1—Materials and Methods

A. Materials

N,N-dimethylethylamine alane (0.5M in toluene), titanium(IV) isopropoxide (99.999% trace metals basis), 1-octene (98%), 1-decene (94%), 1,7-octadiene (98%), 1,9-decadiene (98%), 1,13-tetradecadiene (90%), 1H,1H,2H-perfluoro-1-decene (99%), ethylenediaminetetraacetic acid disodium salt dihydrate (BioUltra, 98.5-101.5%), zinc sulfate heptahydrate (99.999% trace metals basis), sodium hydroxide (ACS Reagent, ≥97.0%, pellets), 1-dodecyne (98%), 2-heptyne (98%), chloroform (CHROMASOLV® Plus, for HPLC, ≥99.9%, contains amylenes as stabilizers), chloroform-d (99.8 atom % D), sodium acetate trihydrate (BioXtra, ≥99.0%), xylenol orange indicator, and sodium chloride were provided by Sigma Aldrich. Fisher Scientific provided hydrochloric acid, nitric acid, and glacial acetic acid. Toluene (anhydrous, 99.8%) and tetrahydrofuran (THF, anhydrous, ≥99.9%, inhibitor-free) were also purchased from Sigma Aldrich and distilled over either Na or K metal, respectively, to ensure complete dryness and the removal of dissolved 02. All capping agents were subjected to numerous freeze-pump-thaw cycles to remove any dissolved 02.

B. Synthesis

The organically-coated Al nanoparticles were synthesized using a previously reported variation on Haber and Buhro's AlH₃ decomposition method (Thomas et al., 2013 and Haber and Buhro, 1998). Briefly, a Luer-Lock syringe was used to inject 6.5 mL alane (3.25 mmol) and 25 mL distilled toluene into a round-bottom Schlenk flask. The resulting room-temperature mixture was then heated to 85° C., at which point 0.8 mL Ti(OⁱPr)₄ (0.0334 M in toluene, 0.0267 mmol) were injected into the reaction mixture followed by the immediate injection of capping agent (10:1 Al: cap molar ratio). Following a 30-minute reflux period, all solvent was removed and the resulting solid was heated in vacuo at 85° C. to remove any remaining volatile components.

C. Powder X-Ray Diffraction (PXRD)

The PXRD patterns of the Al nanoparticle samples were measured using a Rigaku MiniFlex 600 equipped with a scintillation counter detector and a Cu source operated at 40 kV and 15 mA. Determination of face-centered cubic (fcc) Al was made by comparison to the ICDD Database.

D. Thermal Analysis

Measurements were made using a TA Instruments model Q2000 DSC (differential scanning calorimeter), a TA Instruments model Q500 TGA (thermogravimetric analyzer), or a TA Instruments SDT Q600 simultaneous TGA/DSC instrument. Samples were analyzed under constant air flow from 25° C.-800° C. using a 10° C./min temperature profile.

E. Characterization of Polymer Cap

A Bruker 400 MHz NMR spectrometer and a Shimadzu model FTIR-8400S spectrometer were used to analyze the organic coatings of the Al nanoparticles. For FTIR analysis, samples with an initial 10:1 Al:monomer ratio was used. Prior to NMR analysis, the passivating oligomer layers were extracted from the metallic Al cores. The Al-polymer core-shell nanoparticles were first reacted with 5M NaOH, and the resulting mixture was neutralized with concentrated HCl. Following neutralization, 10 mL of anhydrous toluene were added to initiate separation of the organic layer from the aqueous layer. The aqueous layer was washed 2 more times with toluene to ensure complete separation of the layers. The organic layer was subsequently washed three times with de-ionized water to ensure complete removal of any aqueous phase from the organic layer. The organic layer was then dried under vacuum, and the residual polymer was dissolved in CDCl₃ for NMR analysis. For the poly(alkyne) caps, prior to analysis, the extracted organic phases (extraction performed in toluene) were placed under vacuum to remove bulk solvent, and the extracted polymer caps were heated overnight in vacuo to remove residual solvent. The remaining organic layer was dissolved in CDCl₃ (0.5 mL). ¹³C {¹H} NMR spectra of the extracted caps (extractions performed in toluene) were obtained on a Bruker 400 MHZ NMR spectrometer with 14,000 scans.

F. Electron Microscopy

All images were taken using a JEOL 1200EX TEM operated at 60 kV. Samples were cast on formvar TEM grids provided by Ted Pella. The alkyne capped nanoparticles were also dried in air for 12 hours. Prior to spotting the TEM grids, the materials were dispersed in toluene and sonicated overnight to completely break up any aggregates.

G. Active Al Content Determination

One method for determining the fraction active Al has been described previously (Hammerstroem et al., 2011). Briefly, the active Al content was determined by measurement of H₂ (g) liberated from digestion of an Al nanoparticle sample with NaOH (aq). The total Al content was determined from a compleximetric back titration using ZnSO₄ and EDTA as primary and secondary standards respectively. Each sample was analysed three times.

H. Gas Chromatography and Mass Spectroscopy

Combined gas chromatography-mass spectroscopy (GCMS) was completed on extracted caps (extractions performed in chloroform) using a GCMS-QP2010S Gas Chromatograph Mass Spectrometer from Shimadzu with an electron impact ionization source. The following temperature profile was utilized: hold at 70° C. for 0.5 min, increase at 12° C./min and hold at 125° C. for 5.0 min, and increase at 12° C./min and hold at 250° C. for 5.0 min.

### Example 2—Experimental Results

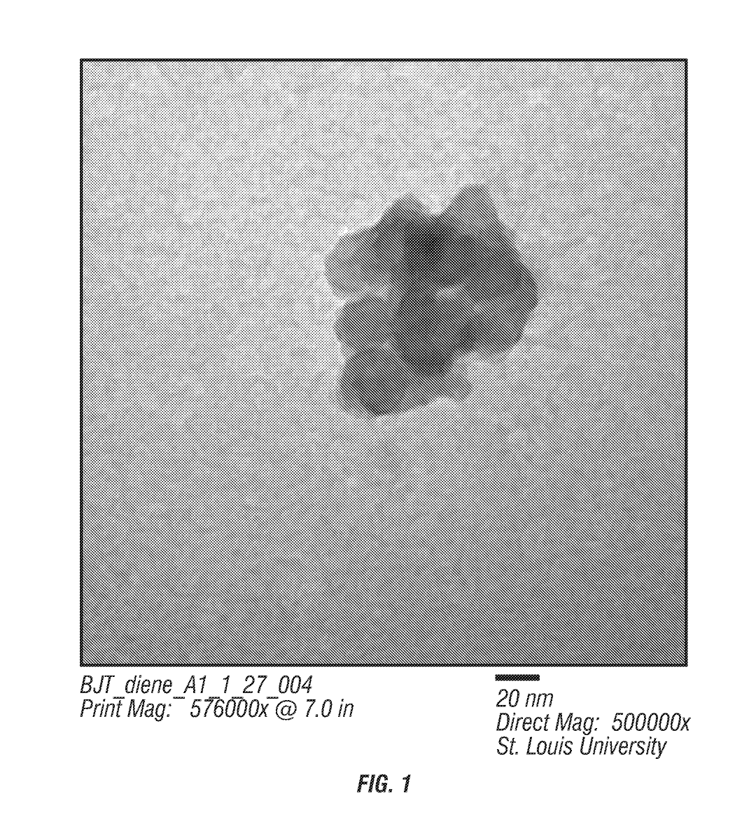

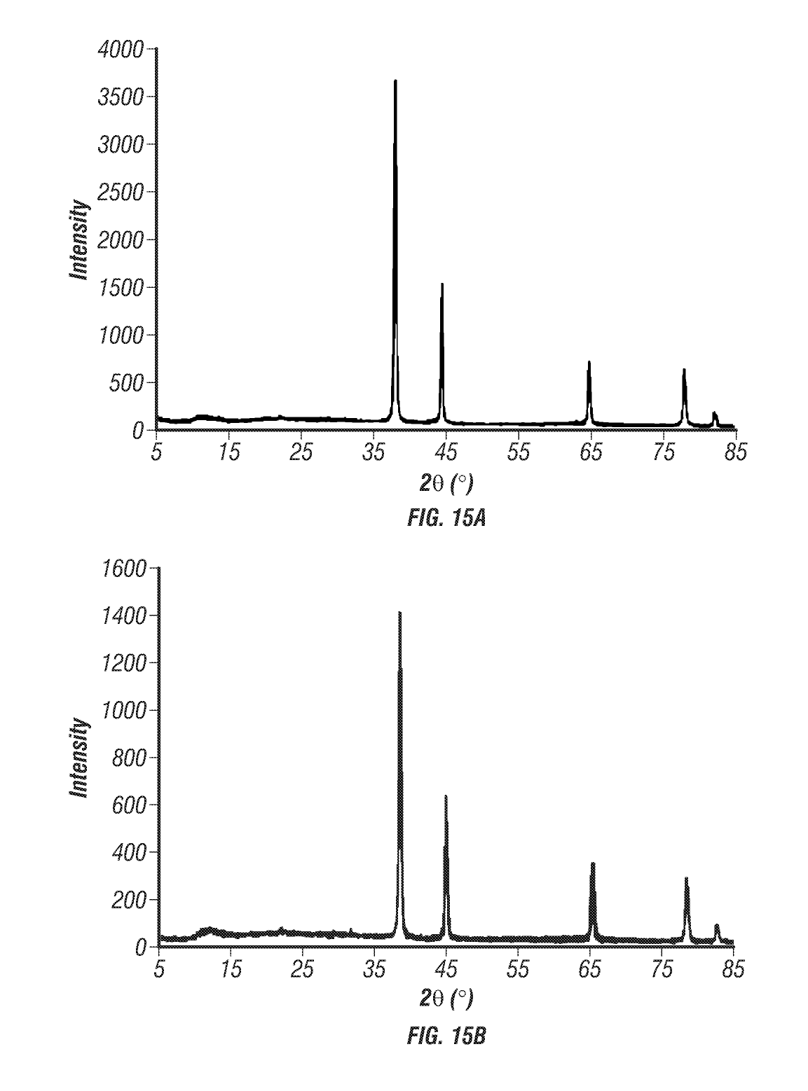

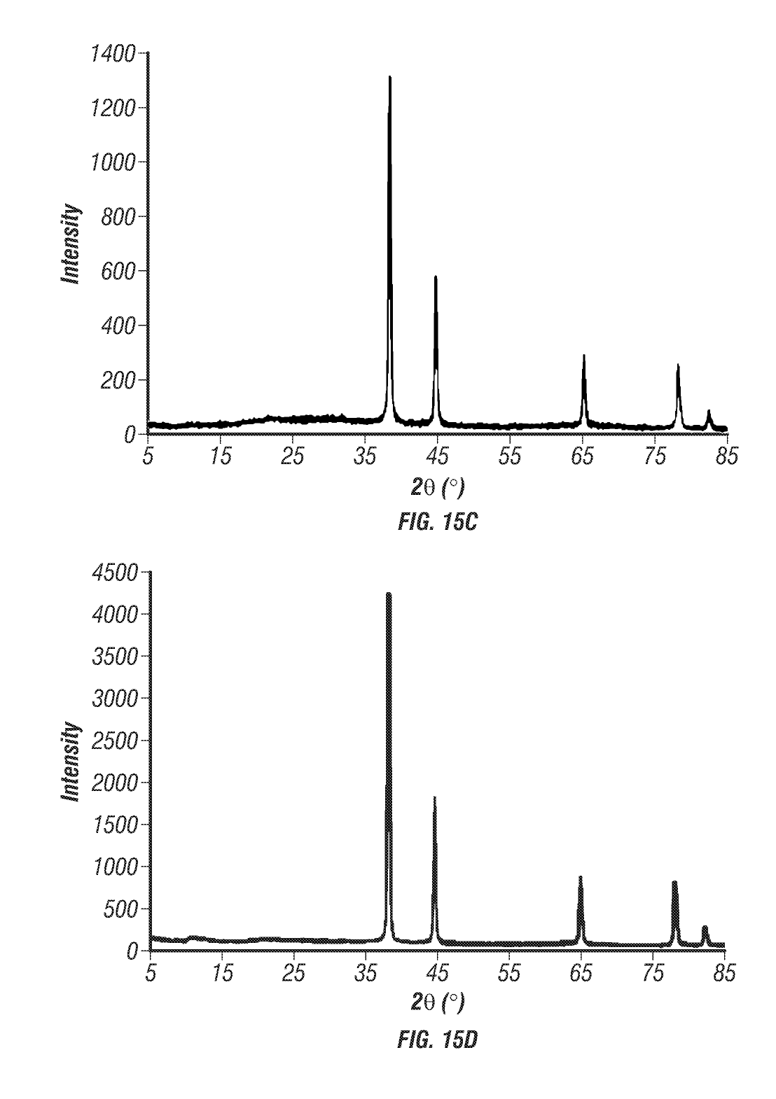

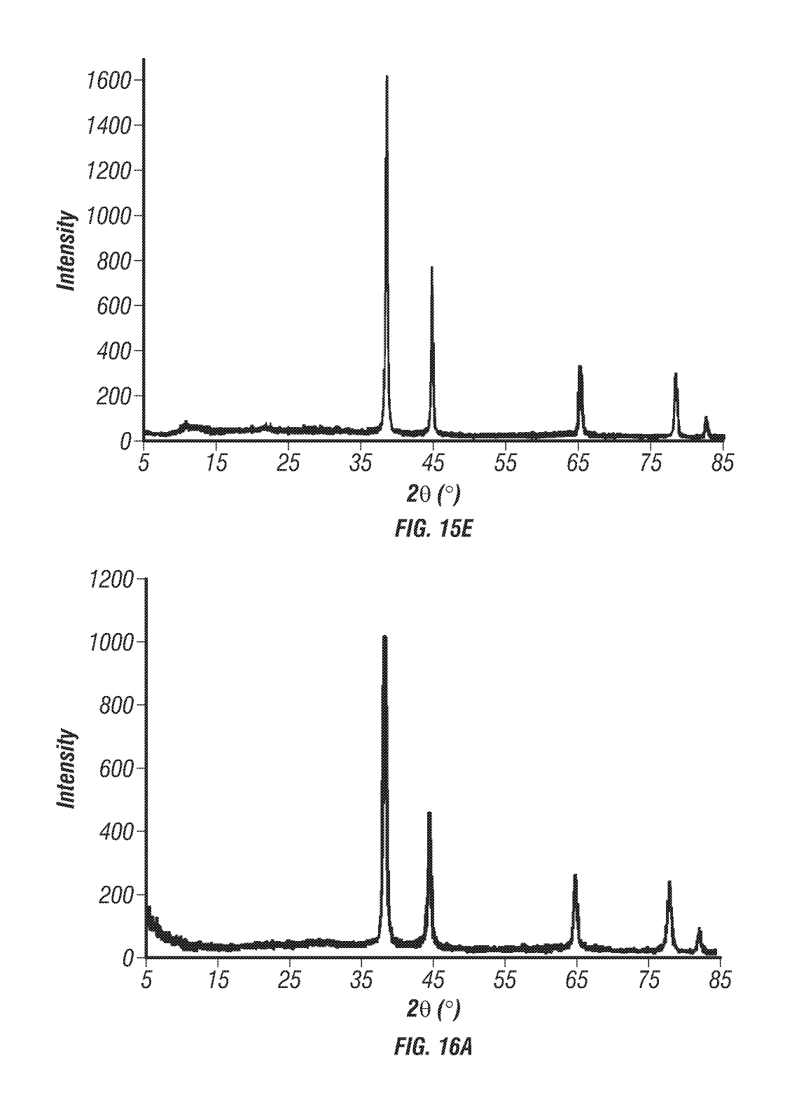

All Al nanoparticles were synthesized by the bottom-up decomposition of alane followed by capping with polymerization of a diene (1,7-octadiene, 1,9-decadiene, 1,13-tetradecadiene) or terminal alkene (1-octene, 1-decene) using an Al:cap molar ratio of 10:1. The presence of fcc crystalline Al cores was verified for each nanocomposite material using PXRD measurement in combination with the ICDD Database. Crystallite diameters (Table 1) were determined using Scherrer peakwidth analysis. While such PXRD analysis provides no proof of single crystallite nanoparticle cores, TEM analysis (FIG. 1, 1,7-octadiene, for example) revealed generally spheroidal single nanoparticles. PXRD-Scherrer treatment thus provided an estimate of the upper limit for nanoparticle core diameters that is 10-15 nm less than that observed by TEM (34 nm, averaged from 35 measurements for poly(1,7-octadiene)-capped nanoparticles). It is believed that the PXRD provides crystallite diameter only, while TEM indicates whole nanoparticle diameter wherein the whole nanoparticle diameter is the core plus capping shell. The PXRD spectra are shown in FIGS. 15A-15E.

TABLE 1
Crystallite diameters and active Al contents for Al NPs capped with
various alkene monomers with a 10:1 Al:cap ratio

| | | Crystallite | Active Al |
|---|---|---|---|
| Capping Agent | Structure | diameter (nm)^{a} | Content (%)^{b} |
| 1,7-octadiene | 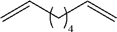 | 31 | 83 ± 6 |
| 1,9-decadiene | 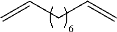 | 27 | 88 ± 6 |
| 1,13-tetradecadiene | 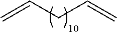 | 26 | 78 ± 5 |
| 1-octene | 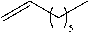 | 29 | 73 ± 10 |
| 1-decene | 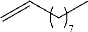 | 31 | 89 ± 3 |

^{a}Determined by Scherrer analysis of the strongest peak at 2θ = 38° in the PXRD pattern.
^{b}Determined from Al speciation analysis and based on active Al(0) content relative to total Al content.

A. Thermal Analysis

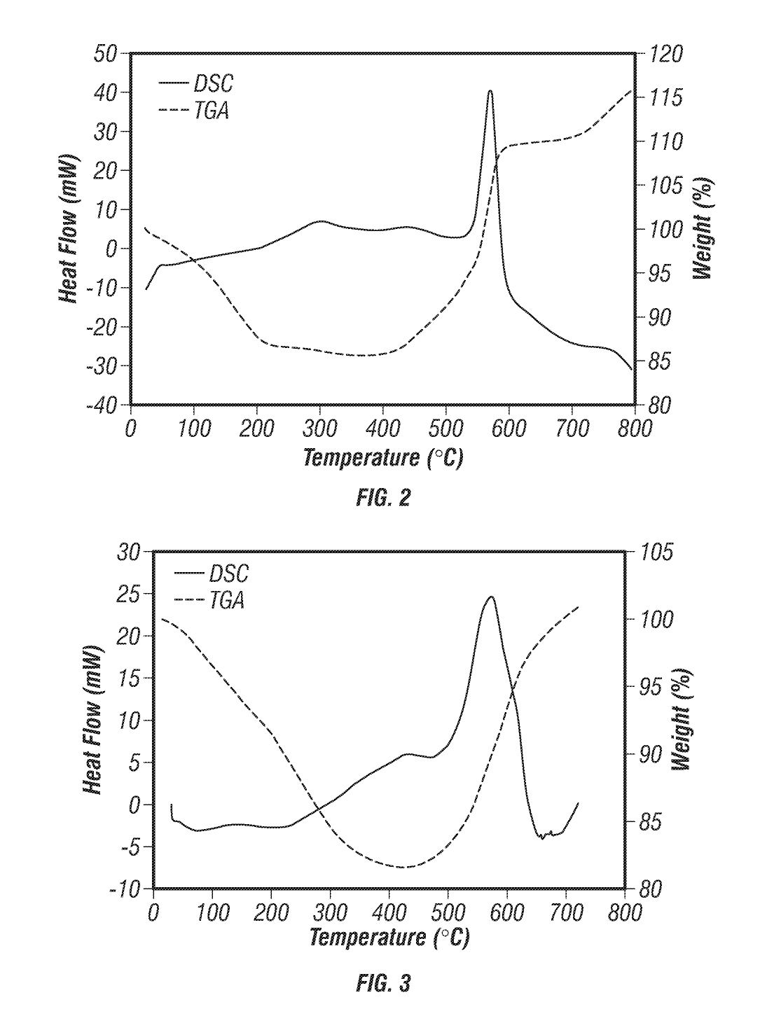

Thermal analysis results for the prepared Al/poly(1-decene) and Al/poly(tetradecadiene) nanocomposites are shown in FIGS. 2 & 3. Similarities amongst the thermal data sets can be immediately noted. First, the onset of nano Al oxidation is well known to occur at ˜560° C., and was noted in the DSC curves seen. The accompanying TGA revealed a mass increase at this point, also indicative of Al oxidation resulting from the formation of the heavier Al₂O₃. Since modifications and/or changes to the organic passivation layer are important to improve the stability of the aluminium nanoparticle, the differences noted in the polymer cap combustion events are highlighted herein.

Some important observations can be made from the TGA data. The mass loss attributed to removal of the polymer cap is quite minimal; ˜15-25% of the total sample mass prior to 400° C. The TGA for poly(epoxydodecane)-capped Al nanoparticles showed a 50% mass loss prior to 400° C. (Hammerstroem et al., 2011); the same trend was observed for poly(epoxydecene) and poly(epoxydecene-co-tetradecadiene)-capped Al nanoparticles (Hammerstroem et al., 2011). These observations potentially give insight towards the degree of polymerization; the reduced mass loss indicates a lower degree of polymerization for the hydrocarbon-coated Al nanoparticles than for the poly(epoxydodecane)-capped Al nanoparticles previously described. The mass decrease for the Al/poly(tetradecadiene) nanocomposite was gradual and leveled off at ˜400° C., an indicator of the highly interconnected nature of the polymer matrix passivating the Al nanoparticles.

For the Al/poly(1-decene) nanocomposite, a sharp mass decrease was observed up to 200° C.; from 200-400° C., a mass decrease is still observed, however, it is much more gradual, almost non-existent. Presumably, the initial mass loss event is due to oxidation of volatile organic species. The next weight loss event presumably related to oxidation of the polymer coating. Several minor exotherms can be observed in the DSC at ˜300° C. and 450° C. Without wishing to be bound by any theory, it is believed that the exotherm at lower temperature may be attributable to oxidation of the 1-decene polymer cap, whereas the exotherm at higher temperature may result from the onset of Al oxidation at low temperature. The mass increase at 450° C. seems to support this theory as well. Complete combustion and removal of the polymer cap would leave behind exposed, unpassivated Al nanoparticles (provided there is no previous oxide passivation). Immediate oxidation of such a material, despite the DSC observations typically observed, was still expected. A minimal oxide coating would delay the process, as is observed in the DSC/TGA data presented here; however, early onset oxidation is still not unexpected.

For the nanomaterials reported here, the mass increased from ˜400-600° C., with a sharp mass increase observed at the Al ignition temperature of ˜560° C. The abrupt increase in mass was expected as the amorphous Al₂O₃ that is formed is much heavier than elemental Al. The unique observation noted from the TGA was the amount of mass gained upon oxidation, ˜20-30%, equivalent to the % mass lost upon combustion of the polymer cap. This was indicative of samples with potentially high active Al contents. The active Al contents, determined from H₂ emission and titrimetric analysis, were indeed unprecedentedly high (Table 1). These samples were not exposed to ambient atmosphere prior to analysis, and that formal aging studies are described below in order to verify the highly stable nature of these materials.

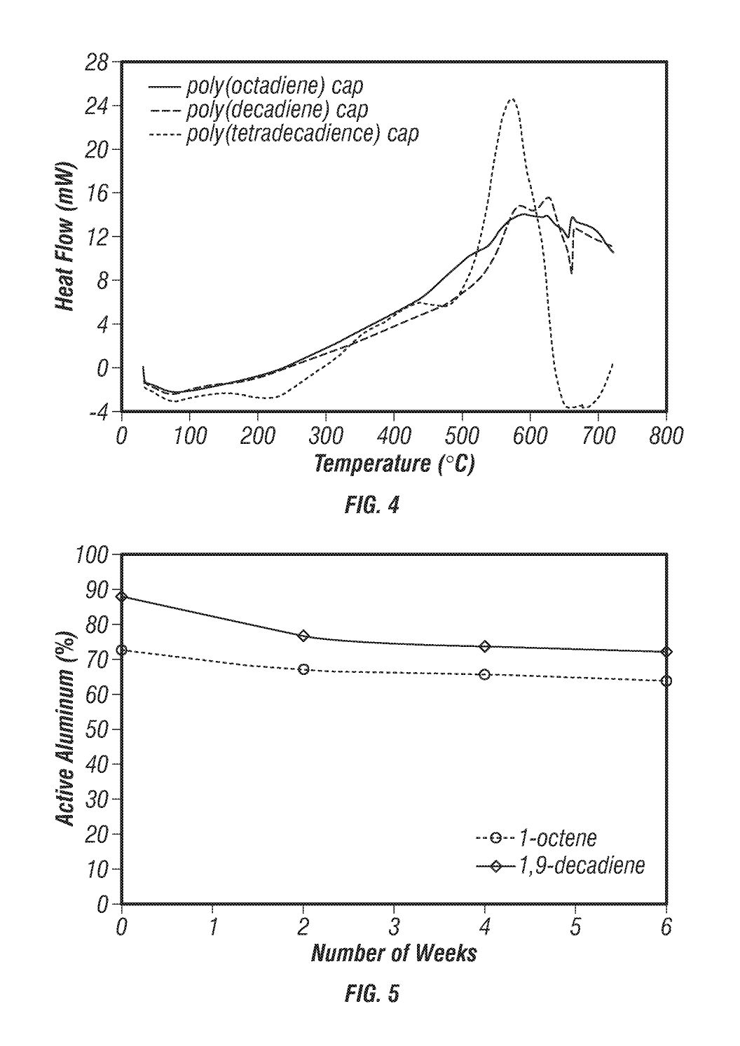

Noticeable differences were observed in the DSC curves for the polydiene-capped Al NPs, shown in FIG. 4. The clearest exotherm indicative of Al oxidation is observed for the Al/poly(tetradecadiene) nanocomposite. In the case of both the Al/poly(octadiene) and Al/poly(decadiene) nanocomposites a second exotherm was additionally present at ˜620° C. along with an Al melting endotherm at ˜660° C.; no trace of these peaks was observed for the Al/poly(tetradecadiene) nanocomposite. These results demonstrate the importance of the hydrophobicity of the capping monomer; polymerization of tetradecadiene led to a highly protective, highly ordered, monodisperse passivating layer. Jelliss et al. demonstrated this effect for various polyether caps; by decreasing the length of the alkyl chain substituent, the inhomogeneity of the passivation layer increases and becomes more polydisperse (Jelliss et al., 2013).

In reference to the DSC curves for the Al/poly(alkene) nanomaterials, the organic combustion occurred over a wide temperature range due to a lack of uniformity within the polymer layer; therefore, some nano Al remained uncombusted and subsequently melted at 660° C. For poly(decadiene)-capped Al nanoparticles, the polymer layer was less polydisperse, and additional Al ignition occurred at elevated temperature (620° C.) upon combustion of the poly(alkene) coating.

B. Stability-Aging Studies

In order to determine the overall stability of these materials, selected samples were stored on the bench top in ambient atmosphere for a 6-week aging period. The preparation of Al nanoparticles that can be stored on a shelf for years at a time with little or no decrease in active Al content is of interest and significant commercial use. The oxophilic nature of metallic Al makes such a feat extremely difficult, especially in warm, humid climates. Despite these obstacles, the hydrocarbon-coated Al nanoparticles maintained a high active Al contents over the 6-week aging period, as shown by FIG. 5. The caps used for these aging studies were selected at random to represent the remaining simple alkenes or dienes. The decrease in active Al content appeared to follow zero order kinetics for all capping monomers tested. Zero order decay is normally observed for Al nanoparticles, while first order decay is normally observed for large, macroparticles. Such behavior was expected as thick oxide layers hinder diffusion of small O₂ molecules, thus lowering the overall reactivity of bulk Al once a thick oxide layer forms at the surface.

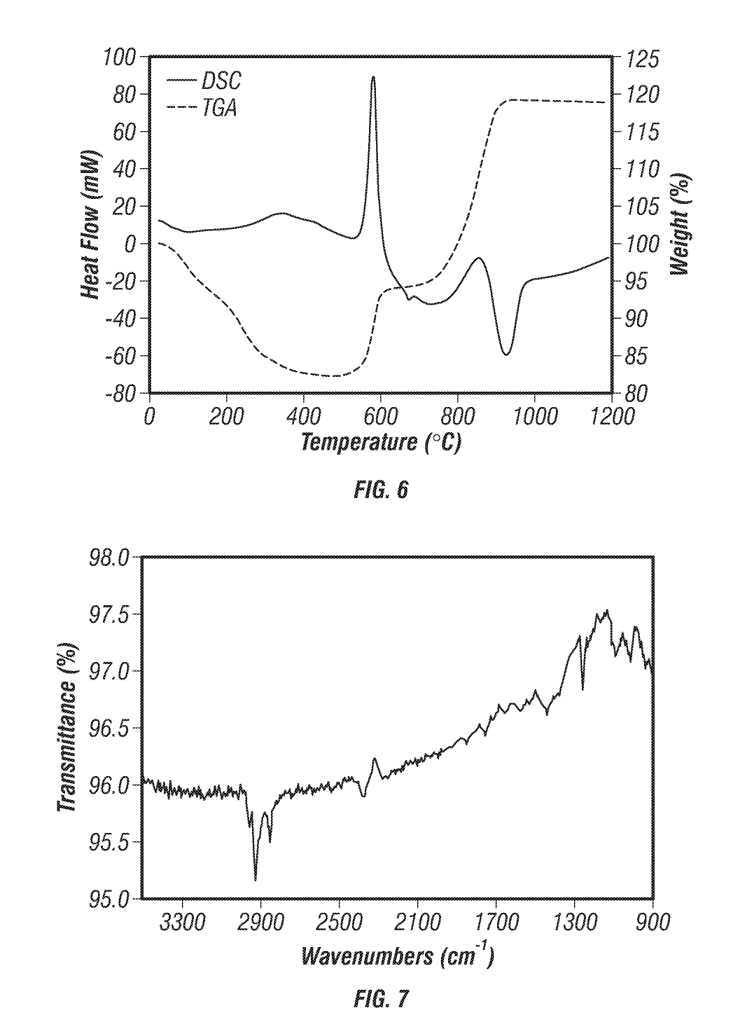

Thermal analysis of poly(tetradecadiene)-capped Al nanoparticles stored under ambient conditions for 13 months showed the presence of metallic Al, as evidenced by the Al ignition exotherm in the DSC at ˜560° C. (FIG. 6). Based on the TGA data, an active Al content of 66% was calculated, an unprecedentedly high Al content given the air exposure time.

C. Analysis of Polymer Capping

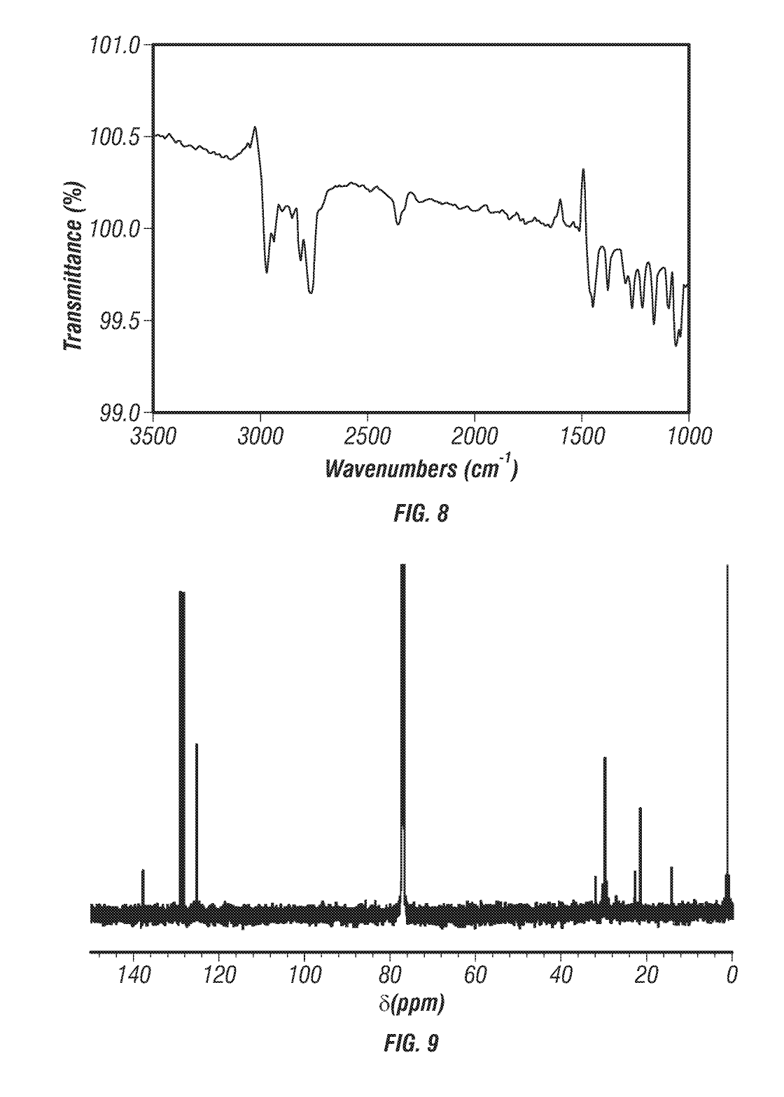

Representative ATR-FTIR spectra for Al nanoparticles capped with polytetradecadiene or polydecene were shown in FIGS. 7 and 8. When analyzing the IR spectrum for Al/tetradecadiene, only one group of peaks, the triplet corresponding to sp³ C—H stretching, were observed. More importantly, several characteristic peaks of alkenes were absent from the spectrum. First, there were no peaks due to sp² C—H stretching, which are normally observed between 3095-3010 cm⁻¹. Second, the stretch of moderate intensity between 1660-1600 cm⁻¹ that is normally associated with monosubstituted alkenes was missing. Together, the presence of alkane signatures and absence of alkene signatures indicated a reduction of the diene to a saturated hydrocarbon during reaction with the nascent Al nanoparticle core. Similar results were observed for Al nanoparticles capped with poly(decene), shown in FIG. 8.

In addition to FTIR, ¹³C{¹H} NMR was used to characterize the extracted polymer caps. 2:1 Al:monomer molar ratios were used when synthesizing these Al nanoparticles for analysis despite the fact that the preferred capping ratio was 10:1. Enough polymeric material for proper analysis when higher Al:monomer ratios were attempted. This observation demonstrated the ability to synthesize highly air-stable Al nanoparticles with a minimal organic passivating layer; additionally, the dependence of the thickness of the passivating layer on Al:monomer ratio was explored.

The chosen solvent used to extract the polymer cap from the Al nanoparticles was toluene. Following the extraction procedure, the obtained polymer was heated overnight in vacuo to remove residual toluene; however, some trace solvent was still present, and evidence of that residual toluene was noted in each of the NMR spectra presented here (δ 21.4, 125.4, 128.3, 129.1, 137.8). A triplet centered at δ 77 ppm corresponding to CDCl₃, the solvent used for NMR, was also present in each of the NMR spectra.

In reference to the ¹³C {¹H} NMR spectrum of the 1-decene polymer cap (FIG. 9), the series of peaks located between 10-35 ppm (with the exception of the peak at 21.4 ppm corresponding to the methyl group carbon of toluene) can be attributed to the alkyl chain of the polymer. The peaks centered at δ 30 correspond to methine carbons of the polymer. The peak at δ 22.9 was likely linked to methylene carbons, and finally, methyl carbons are likely responsible for the peak at δ 14.1. The main region of interest lies between δ 120-140, the C═C region. After subtracting the aromatic toluene peaks, no presence of a C═C bond was observed, thus indicating complete reduction of alkene to alkane. A 2:1 Al:monomer molar ratio used for these studies normally does not result in the production of stable Al nanomaterials as was shown by Hammerstroem et al., mainly due to the increased solution viscosity and reduced diffusional kinetics resulting from the presence of unreacted monomer (Hammerstroem et al., 2011).

No free-radical polymerization initiator was used in the synthesis of these nanomaterials, thus indicating that the Al nanoparticle core itself was responsible for the alkene polymerization. This process (herein called PIERMEN) was a direct result of incipient Al nanoparticles formed in situ. In elemental form, Al is considered electron-rich and can readily donate the extra electrons as evidenced by Al's highly negative standard reduction potential. The use of oxide-passivated Al nanoparticles to polymerize organic monomers has proven unsuccessful; Crouse et al. attempted polymerization of various alkene-containing monomers on the surface of oxide-passivated Al nanoparticles in the absence of an initiator but was not successful (Crouse et al., 2010).

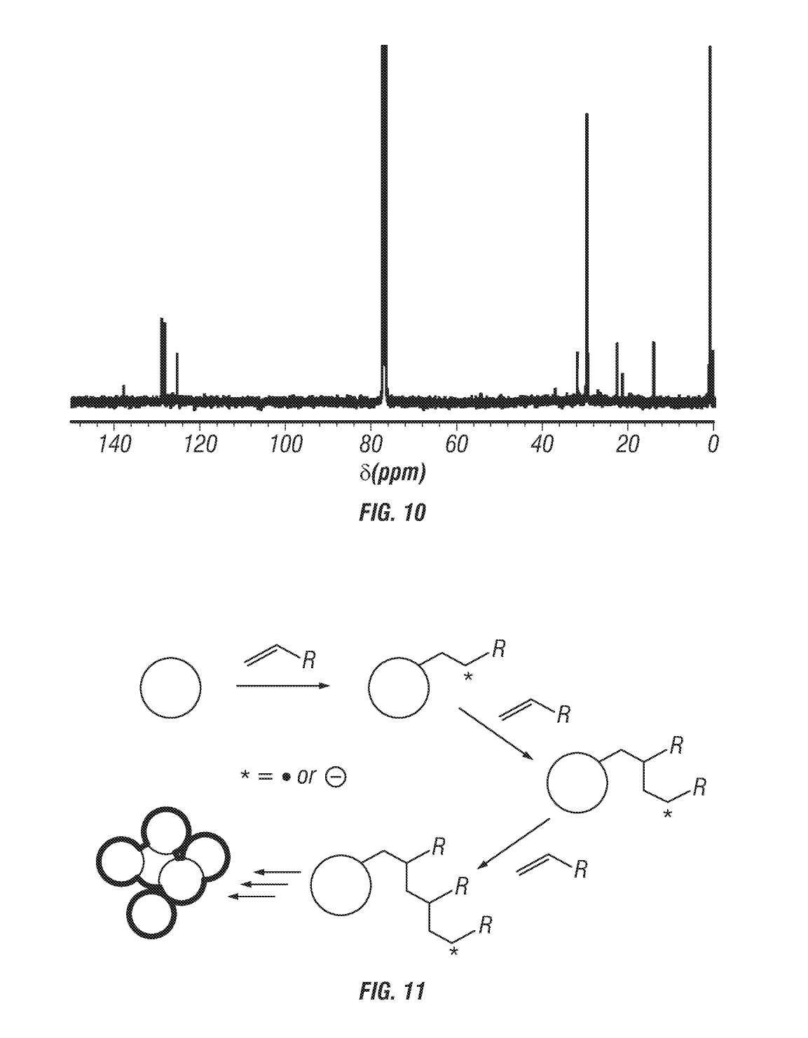

Although no alkene resonances were noted in the ¹³C{¹H} NMR spectrum for the extracted 1-decene polymer cap, the same does not hold true for the extracted diene polymer caps. This contradicts the FTIR data that does not show evidence of alkene; however, this discrepancy may be attributed to the 2:1 Al:diene molar ratio employed for reaction. Therefore, an extraction of the organic layer from a 5:1 Al:diene molar ratio reaction was attempted. The following ¹³C{¹H} NMR (FIG. 10) was obtained for the extracted cap. The NMR for the 1,9-decadiene polymer was very similar to that of poly(decene). First, the same peaks corresponding to toluene and CDCl₃ were present. Second, aside from the toluene peaks, there were no peaks noted in the alkene region. Finally, the alkane region gave rise to methine carbon peaks near δ 30, methylene carbon peaks near δ 22, and a methyl carbon peak at 14.1 ppm. This data suggested that, as with 1-decene, the alkene functional groups were reduced to alkanes by the Al core. It is important to note that both C═C in the diene were reduced. Since the polymerization of the capping monomer was complete at a 5:1 Al:diene molar ratio, it is likely that the polymerization was also be complete at a 10:1 molar ratio, which supported the FTIR data in FIG. 7. However, it was not feasible to obtain enough of the organic polymer for extraction and subsequent NMR analysis with a 10:1 Al:monomer ratio, the molar ratio described by Hammerstroem et al (2011).

The spectroscopic data discussed above lend evidence towards the polymerization (or, more likely, oligomerization) of alkene monomers. In this process, alkene reduction occurred in the absence of any known polymerization initiators. Possible Ziegler-Natta catalyst system are present in the solution as AlH₃ (possible co-catalyst) and Ti(OⁱPr)₄ (possible catalyst) are also in solution; however, prior to the addition of alkene monomer, AlH₃ was decomposed to its basic elements, Al and H₂. Elemental Al(O) has not been reported as a potential Ziegler-Natta catalyst component—only as a scaffold for the attachment of a Ziegler-Natta catalyst system (Roy et al., 2003; Brousseau and Dubois, 2005; Dubois et al., 2007).

Alkene polymerization was not solely limited to a Ziegler Natta mechanism as both free-radical and anionic polymerizations are also plausible. The free-radical mechanism typically requires an initiator easily capable of forming a radical species, such as an azo species or peroxy species. The radical initiator is unstable and will readily add to the C═C bond via the most electron-deficient carbon, thus reducing the alkene down to an alkane. Transfer of a π electron generates an additional radical species, thus initiating the polymerization cascade. The anionic mechanism is initiated by addition of a nucleophile to the C═C bond, leading to formation of a carbanion species. Propagation then ensues upon reaction of the carbanion with additional monomer in solution. Anionic polymerization is favored when the propagating monomer is stabilized by an electron-withdrawing substituent; otherwise, this mechanism is typically not favored.

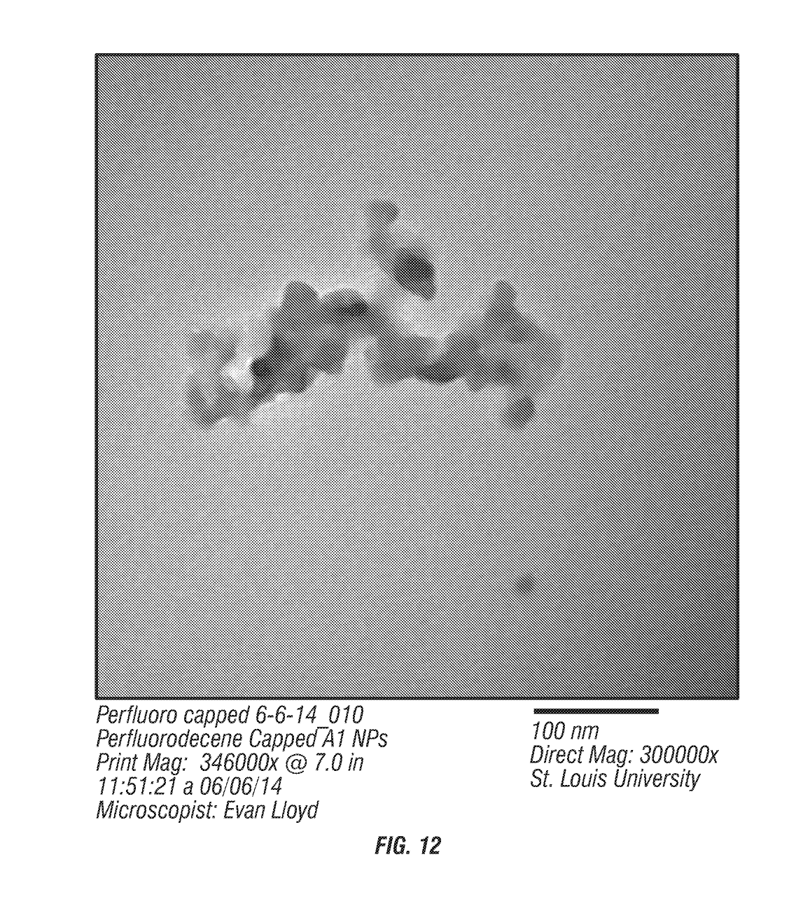

A proposed mechanistic scheme for an Al-initiated free-radical or anionic polymerization is provided in FIG. 12. In both instances, due to the absence of polymerization initiator, the Al nanoparticle core was proposed as the initiator. Both scenarios yielded a linear polymer chain at the nanoparticle surface, with polymerization termination occurring upon depletion of monomer supply in solution. Without wishing to be bound by any theory, it is believed that a free-radical type mechanism is more likely in this instance since stabilization of the carbanion formed from the anionic approach does not appear possible given the nature of the alkene monomers used herein.

Depletion of monomer in solution following polymerization led to radical coupling and, inherently, cross-linking between individual polymer chains at the nanoparticle surface. Radical coupling served as a means to reduce defects within the capping layer, thus allowing for more effective nanoparticle passivation by reducing the probability of oxidative species diffusing to the Al nanoparticle core.

D. Use of Perfluorodecene for Al NP Capping

A TEM image of the poly(perfluorodecene)-capped Al NPs is provided in FIG. 12. The particles were spherical in nature and ranged from 10-30 nm in diameter. Some of the particles appeared to have core-shell morphology, indicating the presence of the perfluoro cap at the NP surface. Presumably, PIERMEN occurred here as well and in a similar fashion as that observed for 1-decene polymerization and passivation. Without wishing to be bond by any theory, it is believed that the polarity associated with the C—F bond decreased the it electron density of the C═C bond, thus strengthening the oxidation environment for the Al.

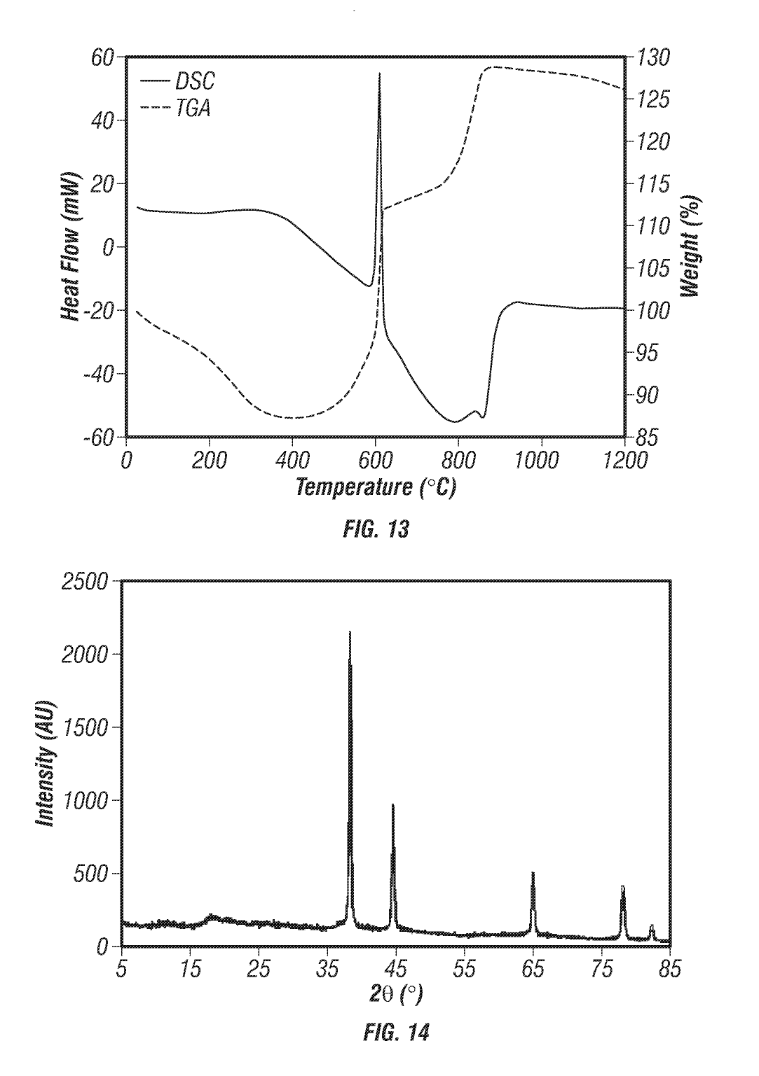

The DSC/TGA data for these nanomaterials, shown in FIG. 13, showed interesting behavior. The Al ignition event occurs at 610° C., a slightly higher temperature than that observed for Al nanoparticles capped with poly(alkenes). The mass gain observed in the TGA at the ignition point was sharp yet substantial, as noted by the 25% increase. Additionally, a subsequent exotherm, although slight, was observed in the DSC at ˜825° C. and was attributed to a separate Al oxidation event. A significant mass gain was also apparent, thus supporting the notion of Al—Al₂O₃ conversion.

Based on the mass gain events, the active Al content of the perfluorinated Al NPs was determined to be 70%. These fluorocarbon capped Al nanoparticles can be stored in water, normally an impossible feat given Al's high tendency towards oxidation in moist environments. The particles were stored in a H₂O-filled vial for one week, and the PXRD of that material shows strong fcc Al peaks with no evidence of Al hydroxides (FIG. 14).

### Example 3—Alkyne Capping of Al Nanoparticles

Upon addition of Ti(OⁱPr)₄ to the reaction vessel, the mixture underwent a significant color change, turning from clear to dark brown, signifying the formation of elemental Al NPs. Over the course of the reflux, the solution went from dark brown to black. The obtained solids were dark grey to black fine powders. When working with 1-dodecyne, all AlH₃:monomer molar ratios tested (1:1, 2:1, 5:1, 10:1, 12:1, and 15:1) were stable in air. In the case of the 1:1 sample, a plastic-like material, with clear outer edges and a defined black core, was obtained; this sample was unreactive and resisted degradation in basic conditions for at least three hours. All other molar ratios afforded materials that had a delayed reaction in water, but after several minutes, the materials began to degrade. For 2-heptyne capped materials, the 1:1 molar ratio sample was highly pyrophoric, but all other molar ratios were stable in air. Those that could be handled on the bench top were very quick to react in water.

A. Powder X-Ray Diffraction

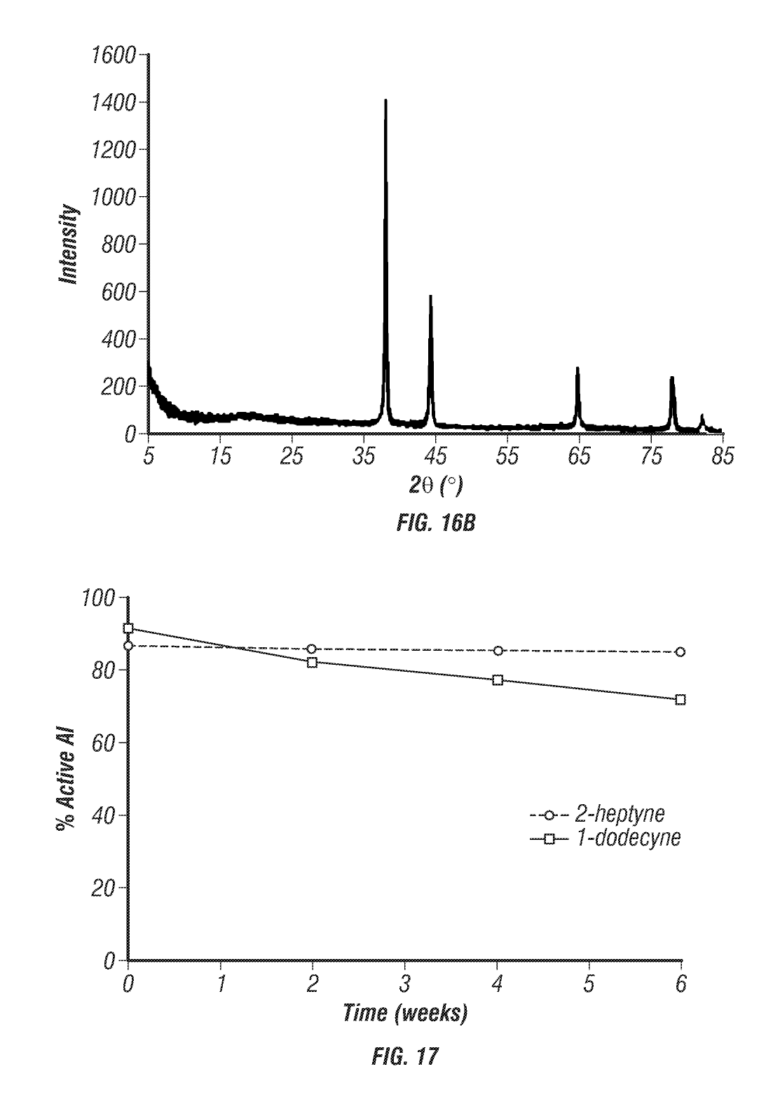

X-ray diffraction patterns can be found in FIGS. 16A & 16B. When comparing these patterns to the ICDD database, it is apparent that fcc Al was, in fact, produced using this synthetic protocol. Particle diameters were determined through Scherrer width analysis and can be found in Table 2.

TABLE 2
Particle diameters and active Al contents of nanocomposites capped with
internal or terminal alkyne monomers

| | | Particle | |
|---|---|---|---|
| Capping | | Diameter | Active Al |
| Monomer | Structure | (nm)* | Content (%) [symbol] |
| 1-dodecyne | 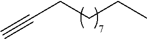 | 30 | 90 ± 4 |
| 2-heptyne | 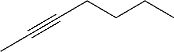 | 21 | 88 ± 2 |

*Particle diameters determined by Scherrer analysis of the 2θ = 38° peak. [symbol]
Active Al content determined for 10:1 samples.

B. Air Stability

The initial, unexposed, active Al contents, which can be found in Table 1, for these nanomaterials are exceptionally high. Additionally, these nanomaterials result in exceptional air stability (FIG. 17) exhibited by these materials, especially in the case of 2-heptyne capped Al NPs, which only lost ˜2% of active content over the six week aging period. Linear regression suggests that the particles oxidize with zero order kinetics; if these trends continue, the Al/1-dodecyne and the Al/2-heptyne nanocomposites will resist complete oxidation—reach an active Al content of 0%—for at least 6 months and 5 years, respectively.

The difference in air stability is likely to have resulted from the presence of an acidic proton in terminal alkynes. It is probable for the Al core, with its high electron density, to transfer electrons to the terminal protons, forming hydrogen gas. However, this electron transfer reduces the number of binding sites for the organic monomer at the particle surface. Thus the particles capped with 1-dodecyne are likely to have a less effective passivation shell.

C. Kinetics of H₂ Production

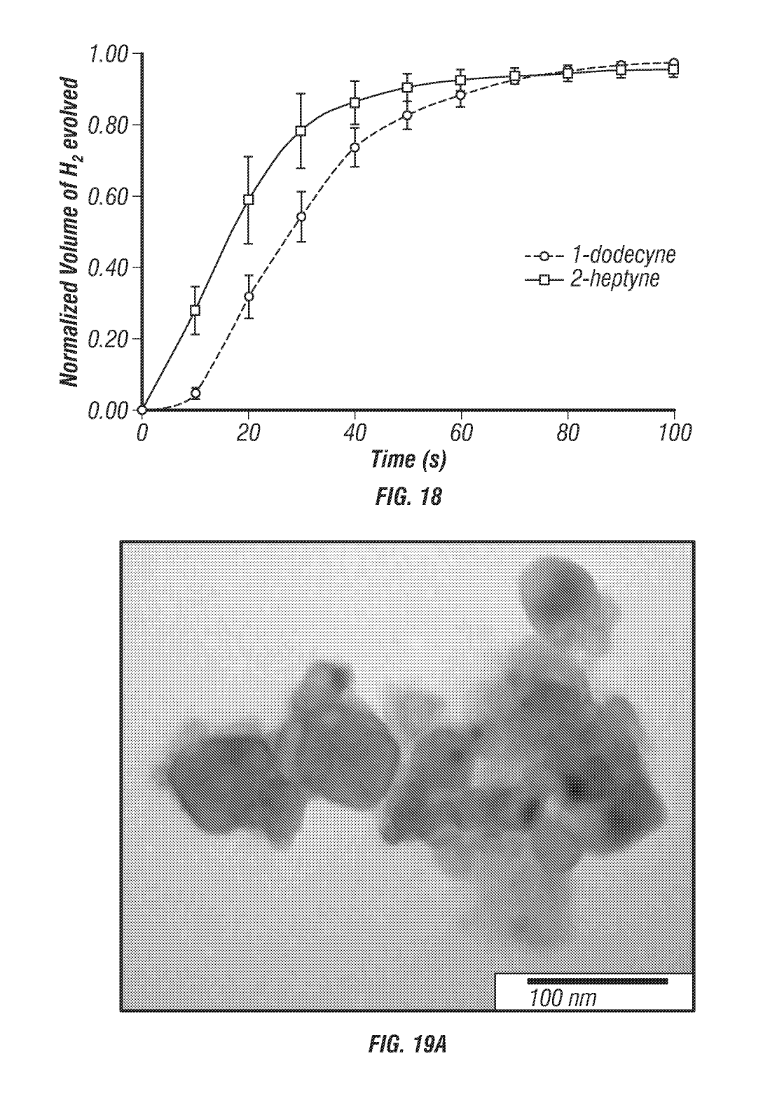

As shown in FIG. 18, it can be seen that the Al NPs capped with 1-dodecyne have an approximately 10 second period where they do not react in the presence of basic conditions. This delay in reactivity is likely due to the longer chain length of 1-dodecyne, which contributes to an increased hydrophobicity of the organic coating, when compared to the 2-heptyne monomer. However, if this delay period is ignored, the two nanocomposites have fairly similar rates of reactivity, suggesting that the passivation shells are fairly similar in construction.

D. Electron Microscopy

FIGS. 19A & 19B show the transmission electron microscopy (TEM) images of the two nanocomposites. For both images, it is clear that a thin organic capping layer, marked by the lighter contrast, surrounds a spherical metal core, marked by the darker contrast, suggesting that core-shell materials were produced using this synthetic protocol. The particles shown in these images range in diameter from 19-50 nm, for Al/1-dodecyne, and from 20-65 nm, for Al/2-heptyne, which is in agreement with the particle sizes determined from Scherrer analysis. In the TEM for both Al NP systems, crosslinking between the organic layers of adjacent particles is occurring. There also appears to be some agglomeration, which is due to the reactive nature of the metallic core and is an inherent issue with nano-scale Al.

E. Thermal Analysis

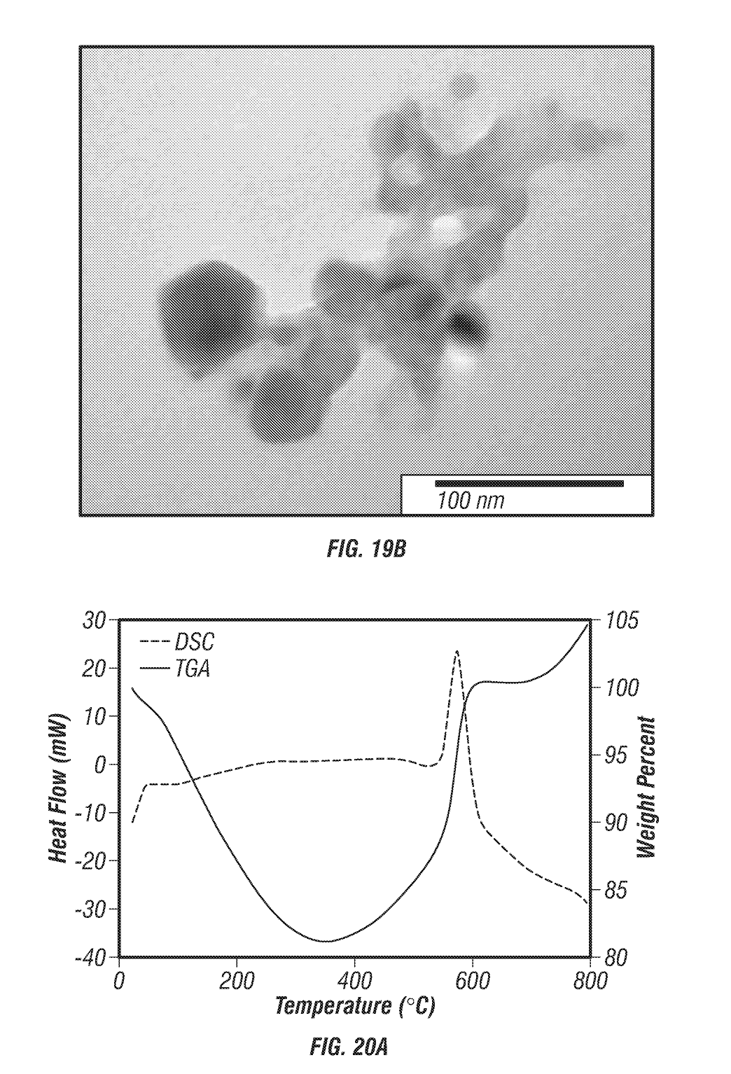

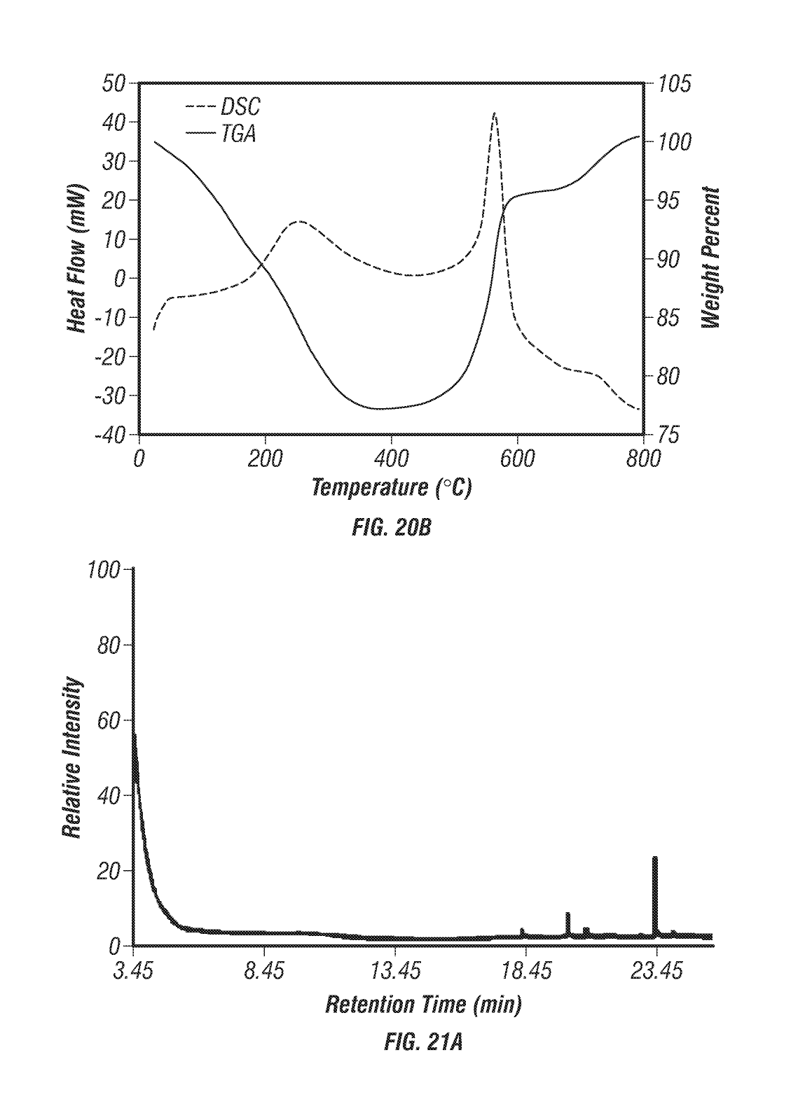

FIGS. 20A & 20B show the DSC and TGA curves for Al/1-dodecyne and Al/2-heptyne nanocomposites, respectively. From these figures, it can be noted that Al ignition events occur at ˜560° C. in both DSC curves, which is in agreement with the established oxidation event of nanoscale Al (Hammerstroem, et al., 2011; Jelliss, et al., 2013; Jelliss, et al., 2014; Thomas, et al., 2013). A corresponding mass gain, due to the oxidation of the Al core to form amorphous Al₂O₃, is present in both TGA curves. The mass gains for both samples are rather significant, ˜25%, suggesting that these nanomaterials possess relatively high active Al contents, further supporting the data in Table 2. Since the Al ignition and oxidation events have been previously studied, this focus will shift towards the combustion of the organic capping layers.

Each DSC curve has a significant exotherm prior to 100° C. These can be attributed to volatile organics, most likely residual solvent that remained in the system. From here, several observations can be made about the thermal analysis of the two nanocomposites. To begin, the two DSC curves have very different exotherms that can be attributed to the combustion of the organic capping layer. For the Al/1-dodecyne system, a distinct exotherm can be seen near 240° C., suggesting that the capping layer is fairly monodisperse. However, for the Al/2-heptyne system, there is a broader exotherm centered around 230° C., which indicates that the internal alkyne capping layer is possibly more polydisperse than that of the terminal alkyne. This is likely to be a result of shorter chain length, which has been previously shown to increase polydispersity of the capping layer (Jelliss, et al., 2013). Furthermore, the center of these organic combustions are higher than the boiling points of 2-heptyne, 110° C.-111° C., and 1-dodecyne, 215° C., as provided by the manufacturer, which is suggestive of polymer formation.

From the TGA curves, it can be noted that a relatively small mass loss, ˜20%, occurs prior to 400° C., which is likely due to the removal of the organic capping layer, for both samples. Previous work with epoxides and epoxyalkenes as capping monomers has shown mass losses of up to 50% during the organic combustion region (Hammerstroem, et al., 2011; Jelliss, et al., 2014; Thomas, et al., 2013). The smaller mass losses for systems with alkyne capping monomers is more desirable since a significant portion of the Al core is not replaced by capping monomer, allowing for greater energy density. The reduction in mass loss can also suggest that if the alkyne monomers are being polymerized, it is to a lesser degree than the epoxide and epoxyalkene monomers.

F. Gas Chromatography-Mass Spectroscopy

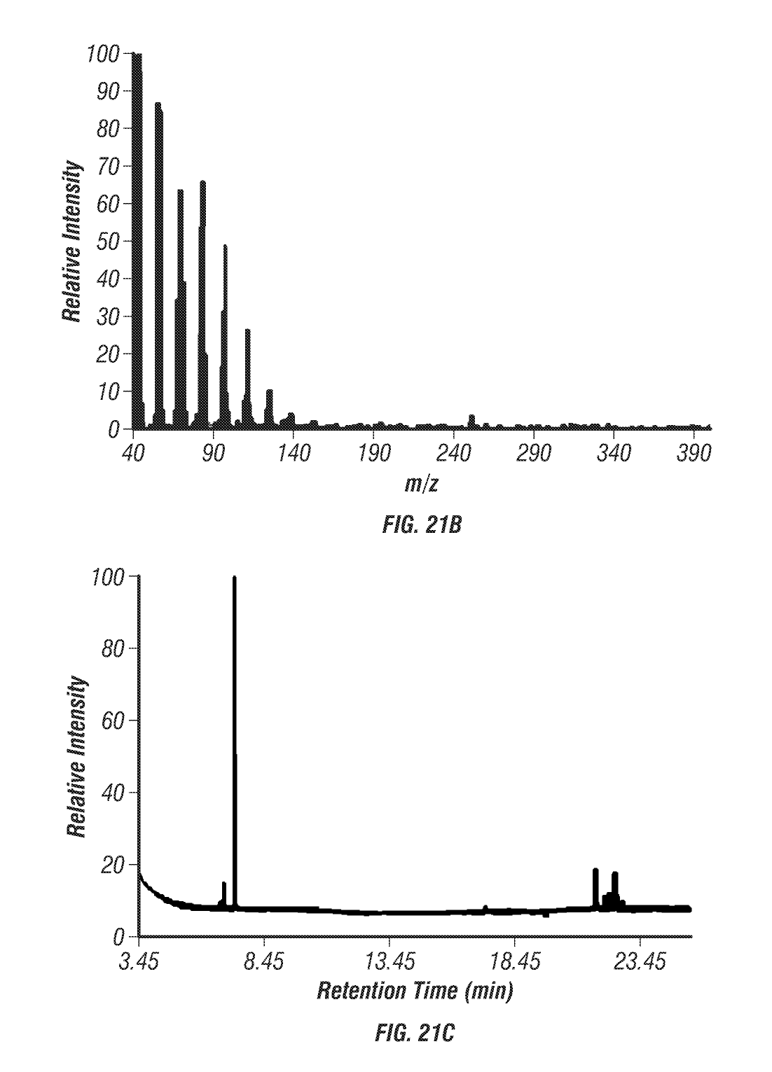

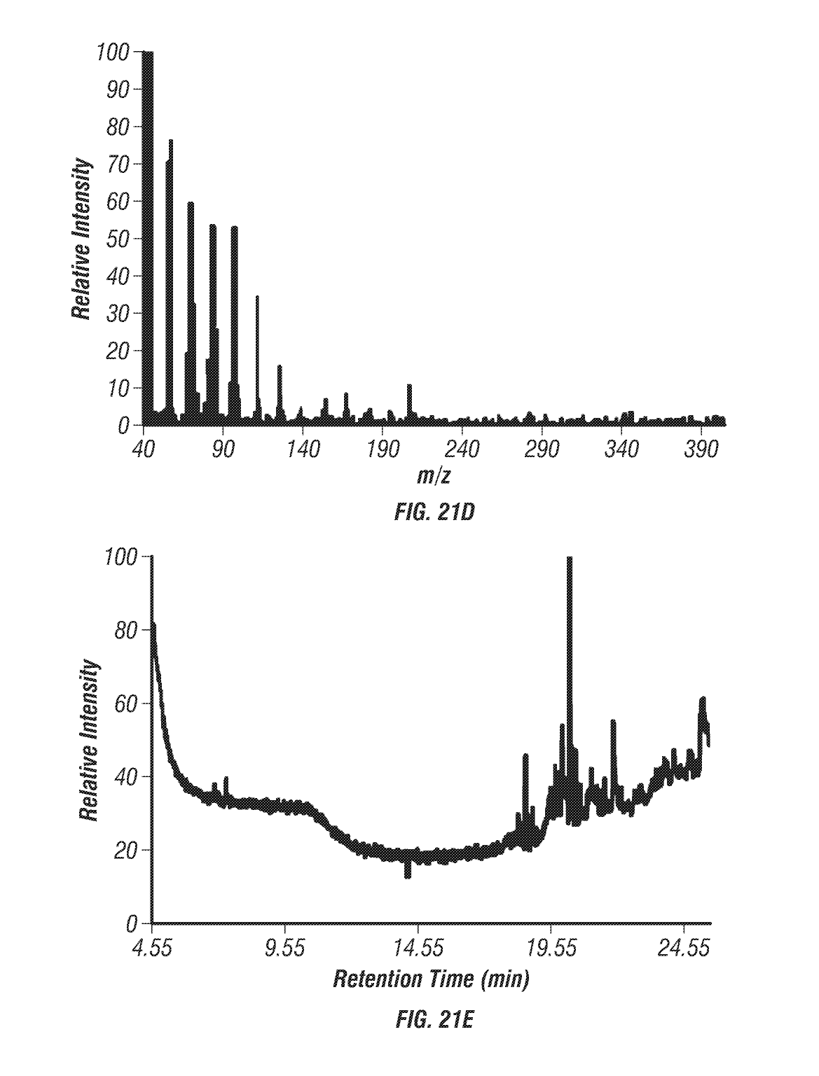

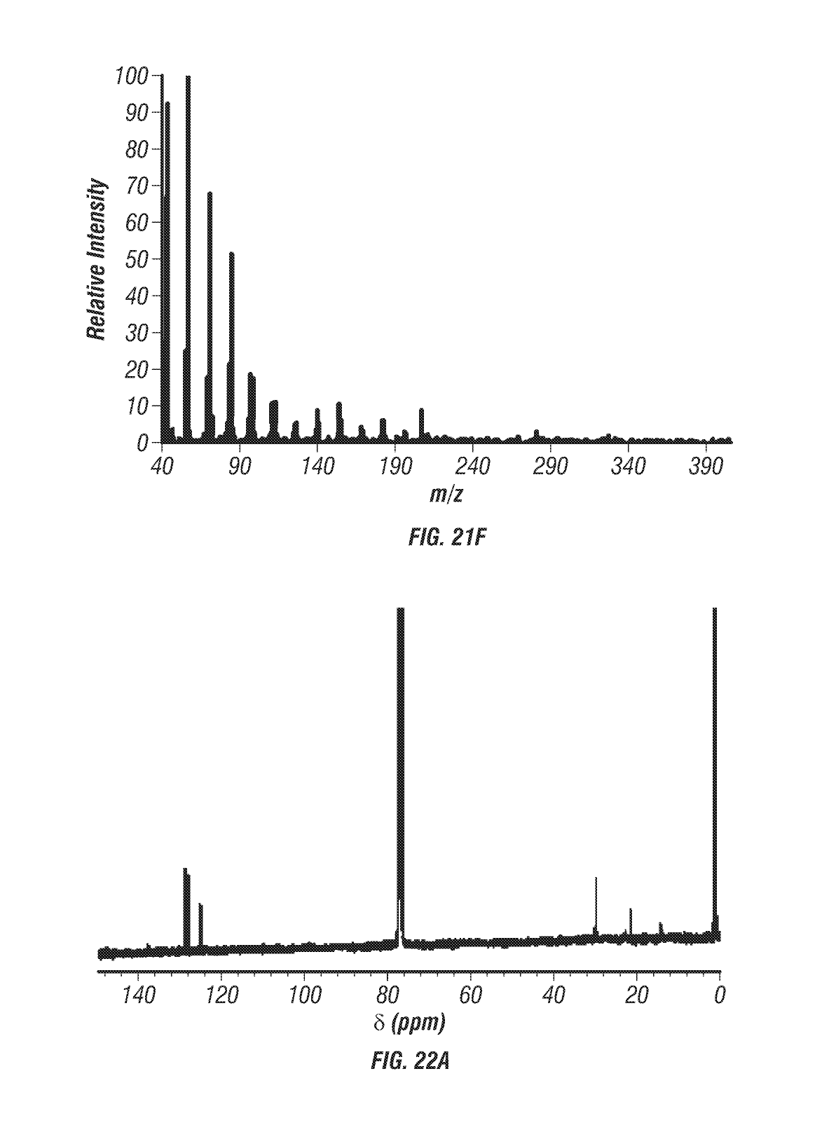

In order to investigate the nature of the passivation mechanism and to confirm polymerization of the alkyne monomers, the extracted caps were subjected to GCMS, and the obtained chromatograms and splitting patterns were compared to those of a commercially available polymer, poly(1-decene). It must be preface that the nanocomposites used for this and other studies on extracted caps were synthesized at a 2:1 AlH₃:monomer molar ratio due to the inability to extract enough organic layer for analysis at higher molar ratios. While this leads to some disconnect between the data gathered and that of a 10:1 system, which has been shown to have beneficial properties, the results obtained can be extrapolated to other molar ratios (Hammerstroem, et al., 2011). Furthermore, the ability to only extract the organic layer from 2:1 systems suggests that the thickness of the capping layer is dependent upon the amount of monomer being used. The results of these studies can be found in FIGS. 21A-21F.

First, it must be noted that the large peak in the chromatogram for oligo(1-dodecyne) at a retention time of 7.308 min is due to residual capping monomer, and the small peak directly adjacent to it is likely due to some sort of contamination, such as residual toluene.

After these two peaks are accounted for, it can be argued that each of the two oligo(alkyne) chromatograms have similar retention times as a known polymer, poly(1-decene). Also, the representative splitting patterns all exhibit a peak spacing of 14, corresponding to the loss of CH₂ groups, which is characteristic of long chain saturated polymers. These similarities to the GCMS data of the commercially available polymer allow for the conclusion that polymers are in fact being produced during the capping process.

The presence of Ti(OⁱPr)₄ and AlH₃ in the initial reaction system allow for the potential of a Ziegler-Natta catalyst system with Ti(OⁱPr)₄ acting as the catalyst and AlH₃ acting as the co-catalyst. However, AlH₃ is decomposed during the addition of the organic monomer, making the Zeigler-Natta catalyst system unlikely. Further, this catalyst system was previous grafted to the metal core via the surface hydroxyl groups of oxide-passivated Al NPs; the lack of these surface hydroxyl groups, therefore, presents a major issue in grafting the system to the particle, making the idea of a Ziegler-Natta system even less likely (Roy, et al., 2003; Fredin, et al., 2013). Since there are no other known polymerization initiators in the system, it is likely that the polymerization of the alkyne monomers is initiated by the metal core through a process known as PIERMEN. This process is unique to unoxidized RMNPs, which are typically electron rich and can easily donate electrons to initiate the reduction of organic monomers. An attempt was made to utilize surface oxidized Al NPs to polymerize alkenes monomers in the absence of known initiators, but this proved unsuccessful (Crouse, et al., 2010).

G. Nuclear Magnetic Resonance Spectroscopy

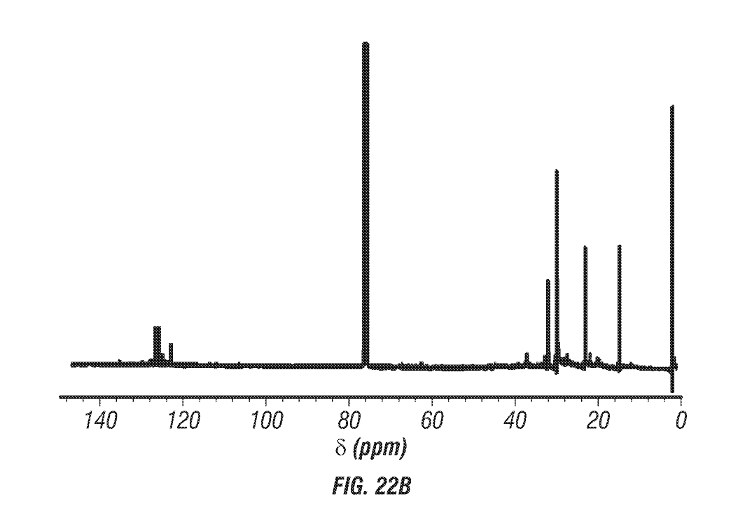

The nature of the polymerization mechanism and the degree of monomeric reduction were explored through ¹³C{¹H} NMR of the extracted caps. The results are shown in FIGS. 22A & 22B.

The polymer caps were extracted using toluene, and following the extraction, the polymer caps were heated in vacuo overnight to removed residual toluene. Unfortunately, trace toluene remained in the sample, and its signatures (δ 21.4, 125.4, 128.3, 129.1, 137.8 ppm) are noted in the NMR spectra presented herein. A triplet centered at δ 77 ppm due to CDCl₃, the chosen NMR solvent, is also present in both spectra.

With regards to the poly(2-heptyne) spectrum (FIG. 22A), it can be seen that there are no peaks in the typical alkyne region, 65-90 ppm. Further, once the aromatic toluene peaks are subtracted, there is no evidence of C═C peaks, which typically occur between 120-140 ppm. Together, these suggest complete reduction of the alkyne to alkane; a rather significant finding since a 2:1 AlH₃:monomer molar ratio does not produce stable Al NPs (Hammerstroem, et al., 2011).

Also of interest, the peaks from 10-35 ppm, aside from the methyl group of toluene at 21.4 ppm, are likely due to the alkyl chain of the polymer. The peak at 14.1 ppm is attributable to the methyl carbons, while the peak at 22.9 ppm is likely due to methylene carbons of the polymer chain. Methine carbons are likely to be responsible for the peaks centered at δ 30. Similar alkyl signatures can be found in the ¹³C NMR spectrum of the poly(1-dodecyne) cap, FIG. 22B, with methyl, methylene, and methine carbon peaks appear at 14.1, 22.7, and 29.7 ppm. Additional groupings of peaks, centered on δ 32 and 37, are also present in the 1-dodecyne polymer cap spectrum; methine and tetrasubstituted carbons are likely responsible for the groupings at 32 and 37 ppm, respectively. The presence of methine and tetrasubstituted carbon signatures is indicative of the formation of branched polymers or crosslinking between adjacent polymer layers or metal cores.

The alkyne region, δ 65-90, is also clear of peaks. The C═C region, after subtracting the aromatic toluene peaks, still has some remaining signatures (127.5 and 130.4 ppm). While the presence of alkene peaks suggests a reduction of the alkyne monomer, it also suggests an incomplete reduction, and therefore an incomplete polymerization. The differential polymerization encountered for the two alkyne monomers is likely a result of the acidic proton of terminal alkynes, which can easily be abstracted by the electron rich metal core. The abstraction of this proton, as discussed previously, diminishes the Al core's ability to donate electron density, thereby reducing its ability to initiate polymerization. While the polymerization of 1-dodecyne is not complete at a 2:1 AlH₃:monomer molar ratio, without wishing to be bound by any theory, it is believed that it would be complete at the optimal 10:1 ratio.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### VII. References

The following references, to the extent that they provide exemplary procedural or other details supplementary to those set forth herein, are specifically incorporated herein by reference:
U.S. Patent Application No. 2012/0009424
U.S. Patent Application No. 2014/0034197
Brousseau and Dubois, Mater. Res. Soc. Symp. Proc., 896:45-55, 2005.
Crouse et al., ACS Appl. Mater. Interfaces, 2:2560-2569, 2010.
Crouse et al., Combust. Flame, 159:3199-3207, 2012.
Dreizin, Prog. Energy Combust. Sci., 35:141-167, 2009.
Dubois et al., J. Propul. Power, 23:651-658, 2007.
Esmaeili et al., Polym. Eng. Sci., 52:637-642, 2012.
Fredin, et al., Adv. Funct. Mater., 23:3560-3569, 2013.
Haber and Buhro, J. Amer. Chem. Soc., 120:10847-10855, 1998.
Hammerstroem, et al., Inorg. Chem., 50:5054-5059, 2011.
Jelliss, et al., Solid State Sci., 23:8-12, 2013.
Jelliss, et al., Int. J. Chem., 3:122-131, 2014.
Jouet et al., Chem. Mater., 17:2987-2996, 2005.
Kaplowitz et al., J. Energ. Mater., 32:95-105, 2014.
Kaplowitz et al., Part. Part. Syst. Charact., 30:881-887, 2013.
Kappagantula et al., J. Phys. Chem. C, 116:24469-24475, 2012.
Li et al., J. Phys. Chem. C, 113:20539-20542, 2009.
Nanostructures and Nanomaterials: Synthesis, Properties, and Applications by Cao and Wang, World Scientific, 2011.
Pantoya and Dean, Thermochim. Acta, 493:109-110, 2009.
Roy et al., Mater. Res. Soc. Symp. Proc., 800:79-84, 2003.
Slocik et al., Nano Lett., 13:2535-2540, 2013.
Thomas et al., J. Nanopart. Res., 15:1-9, 2013.
Thomas, et al., J. Nanopart. Res., 15:1729-1737, 2013.
Thomas, et al., Prepr. Pap.—Am. Chem. Soc., Div. Fuel Chem., 58:1149-1150, 2013.
Watson et al., Combust. Flame, 155:619-634, 2008.
Yarrington et al., J. Propul. Power, 26:734-743, 2010.

1. A method of preparing a nanoparticle comprising:
(a) adding a metal hydride with an organic solvent to form a first reaction mixture;
(b) heating the first reaction mixture to a first temperature from about 25° C. to about 200° C. and adding a titanium complex to form a reactive metal nanoparticle;
(c) adding a capping agent to the reactive metal nanoparticle to form a second reaction mixture, wherein the capping agent is a carbon-carbon double bond containing compound and a carbon-carbon triple bond containing compound; and
(d) heating the second reaction mixture to a second temperature from about 50° C. to about 200° C. for a time period from about 5 minutes to about 4 hours to produce a nanoparticle;
wherein the nanoparticle comprises:
(1) a core consisting of a reactive metal nanoparticle; and
(2) a coating around the core comprising a polymer consisting of the capping agent.

2. The method of claim 1, wherein the metal hydride is aluminum hydride.

3. The method of either claim 1, wherein the metal hydride is AlH₃, LiAlH₄ or NaAlH₄.

4-5. (canceled)

6. The method according to claim 1, wherein the organic solvent is a hydrocarbon solvent.

7-9. (canceled)

10. The method according to claim 1, wherein the first temperature is from about 50° C. to about 100° C.

11. (canceled)

12. The method according to claim 1, wherein the reactive metal nanoparticle is an aluminum nanoparticle or a boron nanoparticle.

13. (canceled)

14. The method according to claim 1, wherein the titanium complex is a titanium(IV) complex.

15-20. (canceled)

21. The method according to claim 1, wherein the capping agent is an alkene_{(C≤18)}.

22-30. (canceled)

31. The method according to claim 1, wherein the capping agent is a double bond containing compound of the formula: 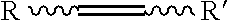
wherein:
R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, nitrile or cyano, nitro, thioether (or sulfide), a second polymeric group, or a PEG group.

32. The method according to claim 1, wherein the capping agent is an alkyne_{(C≤18)} or a substituted alkyne_{(C≤18)}.

33-34. (canceled)

35. The method according to claim 1, wherein the capping agent is a triple bonding containing compound of the formula: 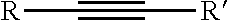
wherein:
R and R′ are hydrogen, alkyl_{(C≤18)}, substituted alkyl_{(C≤18)} such as a haloalkyl_{(C≤18)}, alkenyl_{(C≤18)}, substituted alkenyl_{(C≤18)}, alkynyl_{(C≤18)}, substituted alkynyl_{(C≤18)}, acyl_{(C≤18)}, substituted acyl_{(C≤18)}, aryl_{(C≤18)}, substituted aryl_{(C≤18)}, heteroaryl_{(C≤18)}, substituted heteroaryl_{(C≤18)}, alkoxy_{(C≤18)}, substituted alkoxy_{(C≤18)}, alkylamino_{(C≤18)}, substituted alkylamino_{(C≤18)}, dialkylamino_{(C≤24)}, substituted dialkylamino_{(C≤24)}, or a C1-C18 aliphatic or aromatic group wherein the group is optionally functionalized with one or more amine, aldehyde, epoxide, ester, ether, ketone, nitrile or cyano, nitro, thioether (or sulfide), a second polymeric group, or a PEG group.

36. The method according to claim 1, wherein the capping agent is added to the second reaction mixture in a ratio of the equivalents of the capping agent to the equivalents of the atoms of the reactive metal nanoparticle from about 1:1 to about 25:1.

37. (canceled)

38. The method according to claim 1, wherein the second temperature is from about 50° C. to about 150° C.

39-40. (canceled)

41. The method according to claim 1, wherein the time period is from 15 minutes to about 2 hours.

42. (canceled)

43. The method according to claim 1, wherein the coating is a poly(olefin) polymer or a poly(alkene) polymer.

44-48. (canceled)

49. The method according to claim 1, wherein the nanoparticle comprises a reactive metal content of greater than 50% as determined by Al speciation analysis.

50. (canceled)

51. The method according to claim 1, wherein loss of reactive metal content is less than 50% of the original reactive metal content after 12 months of exposure to ambient air.

52-53. (canceled)

54. The method according to claim 1, wherein the reactive nanoparticle comprises less than 25% of metal oxide.

55-56. (canceled)

57. The method according to claim 1, wherein the crystallite diameter of the nanoparticle is from about 10 nm to about 50 nm as measured by Scherrer analysis of the strong peak of the PXRD.

58. (canceled)

59. A nanoparticle prepared by the method according to claim 1.

60. A nanoparticle comprising:
(a) a core consisting of a reactive metal nanoparticle; and
(b) a self-polymerized coating around the core consisting of a poly(olefin) or poly(alkyne) polymer;
wherein the coating directly covers the core.

61-80. (canceled)

81. A fuel composition comprising a nanoparticle of claim 60.

82-83. (canceled)
